(19) United States
(12) Patent Application Publication
(10) Pub. No.: US 2004/0039990 A1
(43) Pub. Date: Feb. 26, 2004

(54) Automated form and data analysis tool

(75) Inventors: Asif Bakar, Milwaukee, WI (US); Brad Schmitz, Milwaukee, WI (US); Thomas Campbell, Arlington Heights, IL (US)

Correspondence Address: Derek C. Stettner, Michael Best & Friedrich LLP, 100 East Wisconsin Avenue, Milwaukee, WI, 53202-4108, US

(73) Assignee: Xorbix Technologies, Inc., Milwaukee, WI

(21) Appl. No.: 10/402,416

(22) Filed: Mar. 28, 2003

Related U.S. Application Data
(60) Provisional application No. 60/368,484, filed on Mar. 30, 2002.

(51) Int. Cl. G06F 17/00

(52) U.S. Cl. 715/505; 715/513

(57) ABSTRACT

An automated form and data analysis tool. The tool includes a form development module having a design template, a form engine, a form management module, a report module, and an export module. In other embodiments, the invention is an automated form and data analysis tool having a form tool, a feedback tool, an online testing tool, a geographic analysis tool, a forms application and development tool, a data query tool, and a menu tool. The invention provides mechanisms for developing, maintaining, and manipulating forms, and for extracting information from the forms.

### RELATED APPLICATIONS

The present application claims priority to co-pending provisional patent application No. 60/368,484, filed on Mar. 30, 2002.

### FIELD OF INVENTION

The present invention relates to software tools for creating forms. More particularly, the invention relates to a form building tool with the capability to generate and manage databases that are correlated to the forms generated using the tool.

### BACKGROUND OF THE INVENTION

There are a variety of software programs and tools available for generating electronic documents such as forms, surveys, tests, and other items including even Internet content (broadly and collectively these types of documents are referred to herein as “forms”). People who lack an understanding of computer programming may use some of these tools (for example, word processing programs) to generate documents (such as the document you are reading). Even with all the advanced features of such programs, however, the types of forms that can be generated are relatively simple and there is usually no straightforward manner of linking the documents to databases. Other available programs, which generally require relatively advanced computer programming skills to satisfactorily operate, can be used to create more advanced types of forms and related databases. Once created however, modifying the forms to meet changing circumstances or desires is usually a difficult and programming-intensive proposition.

Consider, for example, collecting data over the Internet. One method of gathering information over the Internet is to use a web-based survey. Typically, a webmaster builds a web-site having a survey containing input fields for collection of user input data. The input fields allow a respondent to enter the requested information directly to the web-site interface. The problem with this querying system is that the creator must be proficient in programming hypertext markup language (“HTML”) code and must create the appropriate databases for input data storage. Further, the collected data must be maintained locally on a form of storage media such as a hard disk. Furthermore, changes to a survey, or the need for additional surveys, require a webmaster to modify the HTML code or create an entirely new web-site and corresponding database. Along with these survey creation and management limitations, sorting or “mining” the data within the database usually requires additional programming efforts in the form of modifying a data-mining tool to interface with the database created, or creating a data-mining tool from scratch.

### SUMMARY OF INVENTION

Accordingly, there is a need for a tool to create forms. The invention provides a form development tool for developing, maintaining, and manipulating forms, and for and extracting information from the forms. In one embodiment of the invention, the tool is web-based. The tool provides these and other features, but may still be used by a user who has little or no computer programming skills.

In one embodiment, the invention provides an automated form creation and data analysis tool including a form tool. The form tool may have a design template, a form engine, a form management module, a report module, and an export module. The design template may be written in extensible markup language (“XML”) and may include data representative of form options. The design template may also include data representative of rules and data for validation.

Preferably, the form engine is operable to read the design template and XML code. Upon user initiation, the form engine causes an output device to display a form.

The tool may also include a management template and a manage routine. The management template may include data representative of an activation date, an expiration date, a number of responses, and a date of the last received response. The manage routine is operable to read the management template

The report module may include a report data template, a report format template, and a reporting engine. The report data template may be partially generated by the design template to include data representative of reporting preferences. The reporting engine is operable to read the report data template and the report format template.

The export module may include an export data template, an export format template, an exporting engine, and an export data file. The export data template may be at least partially generated by the report data template. The exporting engine is operable to read the export data template and an export format template.

In another embodiment, the invention provides a form development system having a display device and a processor coupled to the display device. Preferably, the processor is operable to generate a form using a design template, a management template, a report data template, and an export data template, and to execute a rendering engine. Preferably, when a user initiates a view of a form, an export, or a report, the appropriate engines execute by extracting information from one or more of the above templates and causing, in the case of a form or report, at least a portion of the form or report to be displayed on the display device.

Other features and advantages of the invention will become apparent by consideration of the detailed description and accompanying drawings.

### BRIEF DESCRIPTION OF THE DRAWINGS

In the drawings:

FIG. 1 is a schematic diagram of an exemplary computer that may be used in embodiments of the invention.

FIG. 2 illustrates a networked embodiment of the invention.

FIG. 3A illustrates major components and functions of one embodiment of the invention.

FIG. 3B illustrates a form development module of one embodiment of the invention.

FIG. 3C illustrates a form management module of one embodiment of the invention.

FIG. 3D illustrates a report module of one embodiment of the invention.

FIG. 3E illustrates an export module of one embodiment of the invention.

FIG. 4 illustrates a user interface and components of an exemplary form tool.

FIG. 5 illustrates a form and a reports engine included in one embodiment of the form tool.

FIG. 6 illustrates an exports and a manage routine included in one embodiment of the form tool.

FIG. 7 illustrates an exemplary database architecture.

FIG. 8 illustrates the architecture of an exemplary form design definition or template.

FIG. 9 illustrates the architecture of an exemplary report definition or template.

FIG. 10 illustrates the architecture of an exemplary export definition or template.

FIG. 11 illustrates a “New Form” selection step generated in one aspect of a form creation process.

FIG. 12 illustrates a “Settings” tab selection with input fields generated by one aspect of a form creation process.

FIG. 13 illustrates a “Colors” tab selection display generated by one aspect of a form creation process.

FIG. 14 illustrates an exemplary selection of color input fields.

FIG. 15 illustrates a “New Page” selection and exemplary input fields generated by one aspect of a form creation process.

FIG. 16 illustrates a “Field” tab selection and associated query input fields generated by one aspect of a form creation process.

FIG. 17 illustrates a “Response” tab selection and exemplary response input fields generated by one aspect of a form creation process.

FIG. 18 illustrates a portion of an exemplary form generated by an aspect of the form creation process.

FIG. 19 illustrates a “Form” selection as an exemplary step in a form publishing process.

FIG. 20 illustrates an exemplary “Manage” selection of a created form.

FIG. 21 illustrates an exemplary “Activate” selection as another step in the publishing process.

FIG. 22 illustrates an exemplary display and activation input fields for a form generated by one embodiment of the form tool.

FIG. 23 illustrates a “Publish” selection and an exemplary form status display generated by another aspect of the publishing process.

FIG. 24 illustrates an exemplary published form display and field data for publication as an HTTP link or as embedded in a web page.

FIG. 25 illustrates exemplary HTML code for embedding a form into a web-site.

FIG. 26 illustrates an example of a web browser displaying a portion of a published form.

FIG. 27 illustrates a “Reports” selection as an exemplary step in a form reporting process.

FIG. 28 illustrates an exemplary “New Report” selection and associated input fields generated by one aspect of a form reporting process.

FIG. 29 illustrates a display result of a “Run Report” selection for an exemplary form in another aspect of a form reporting process.

FIG. 30 illustrates an “Exports” selection as an exemplary step in a form exporting process.

FIG. 31 illustrates the selection of an export format and associated input fields as generated by an aspect of the exporting process.

FIG. 32 illustrates a display having exemplary export file data.

FIG. 33 illustrates the feedback architecture in one embodiment of a feedback tool.

FIG. 34 illustrates a geographical process architecture in one embodiment of a geographical analysis tool.

FIG. 35 illustrates an architecture of one embodiment of an online testing tool.

FIG. 36 illustrates an architecture of one embodiment of a data query tool.

FIG. 37 illustrates an architecture of one embodiment of a menu tool.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

In some of the examples discussed, terms within quotation marks and capitalized terms are used for convenience and to assist the reader in correlating the description to the drawings. However, these terms should not be considered as having specialized meanings and are meant to be interpreted broadly and generically. It should also be understood that many components and items are illustrated and described as if they were hardware elements, as is common practice within the art. However, one of ordinary skill in the art, and based on a reading of this detailed description, would understand that, in at least one embodiment, components of the invention are actually implemented in software.

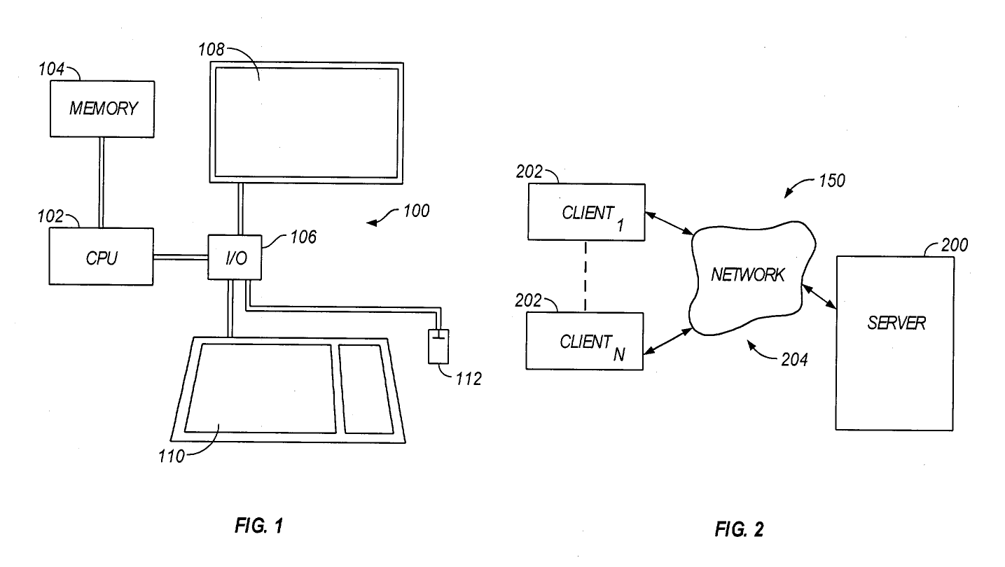

Referring to FIG. 1 of the drawings, components of various embodiments of the invention may be implemented using a conventional computer, such as the computer 100 shown. The computer 100 includes a central processing unit (“CPU”) 102, a memory or data storage device 104, an input/output interface 106, a display device 108, and a plurality of input devices including a keyboard 110 and/or a mouse 112. In general, the exemplary computer 100 may include a variety of other known elements (voice recognition components, drives, peripherals, etc.) and software (operating system software, application software, etc.), and is not limited to the components shown in FIG. 1.

In one embodiment of the invention, the computer 100 may be configured with an operating system such as Windows XP or NT, and a browser, such as Internet Explorer or Netscape Navigator, and the software herein described may be loaded on the computer 100. The computer 100 may then be operated as a stand-alone unit. Alternatively, one or more computers 100 or similar devices may be configured in a client-server relationship where a computer executes the software described herein and a number of other computers access the first computer and use the software to create forms and analyze data. FIG. 2 illustrates an exemplary client-server-based system 150. The system 150 includes a server 200, multiple clients 202, and a network 204. The network 204 may take the form of one or more communications links connected such that information exchange between devices coupled to the network 204 is possible. Examples of networks suitable for use in embodiments of the invention include a local area network (“LAN”), a wide area network (“WAN”), the Internet, an Intranet, and a metropolitan area network (“MAN”).

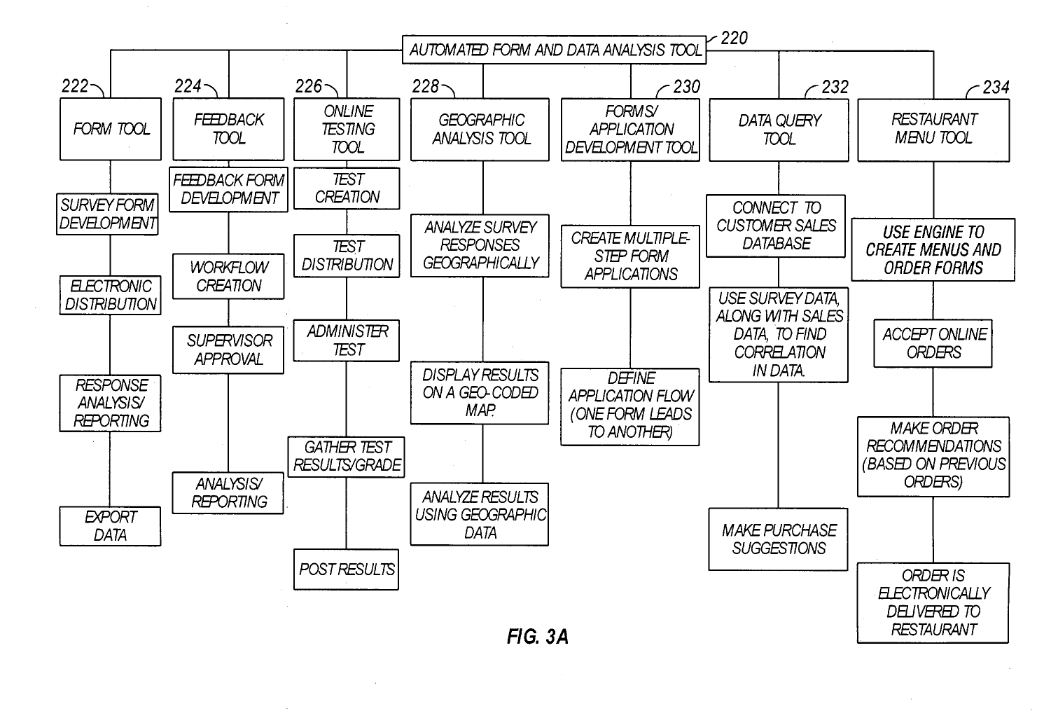

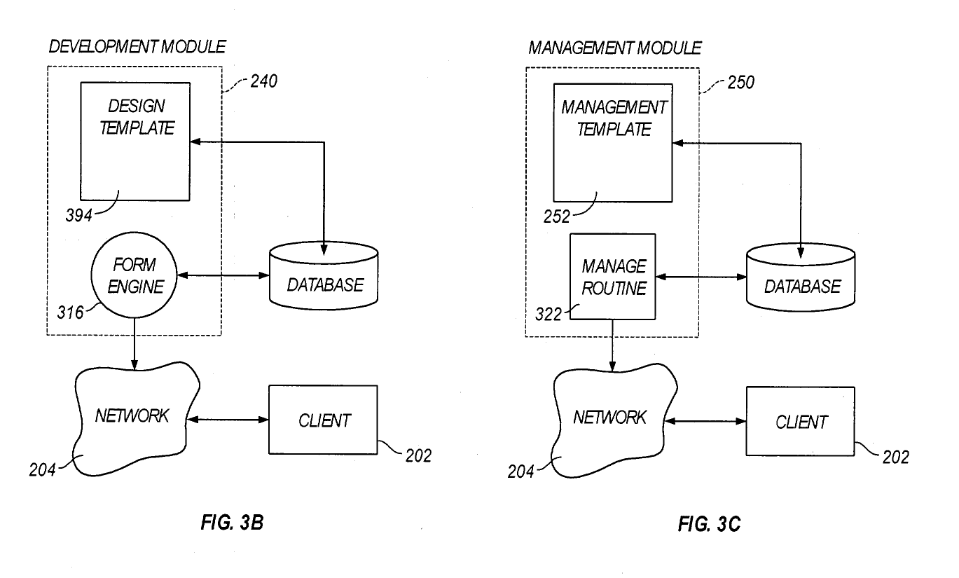

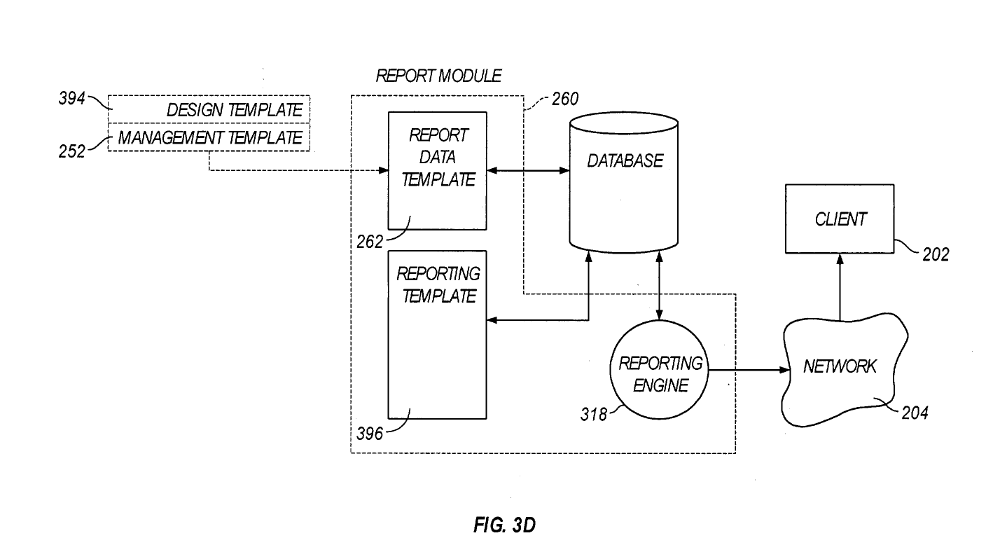

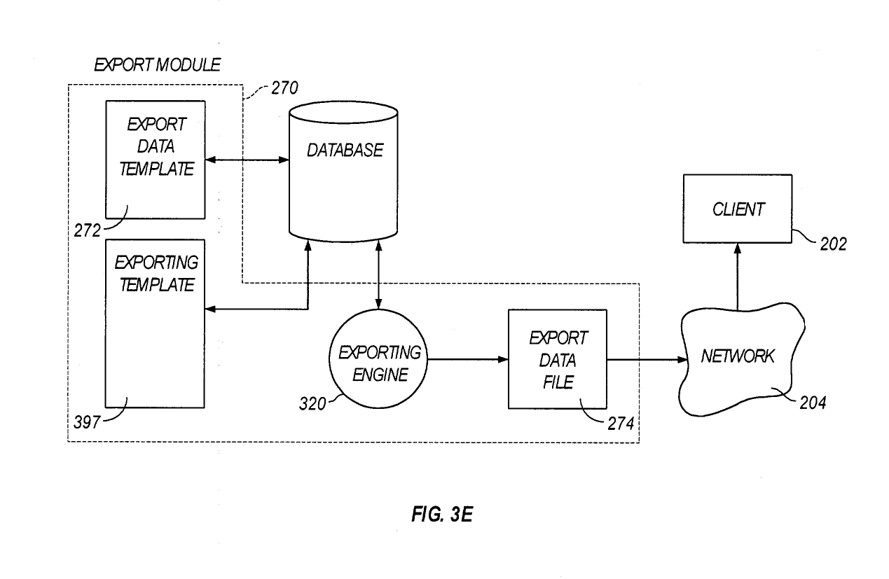

In some embodiments, the invention is a form generation tool operable to execute commands for the creation of web-based forms and to manage respondent data. An exemplary automated form and data analysis tool 220 is shown in FIG. 3. The tool 220 includes a number of sub-tools including a survey or form tool 222, a feedback tool 224, an online testing tool 226, a geographic analysis tool 228, a forms and application development tool 230, a data query tool 232, and a menu tool 234. These tools are described in greater detail below. Briefly, however, as may be seen by reference to FIG. 3, the form tool 222 allows a user to develop electronic surveys, distribute the surveys electronically, analyze the responses received from the surveys, generate reports on the same, and export the collected data to an applicable database. The feedback tool 224 allows a user to develop a feedback form, establish a workflow or internal procedure for distributing the feedback form, incorporate a supervisor approval process into the feedback procedure, and generate analyses and reports from the information collected in the feedback forms. The online testing tool 226 allows a user to create examinations or tests, distribute those tests, administer the tests, grade the tests, and then post the results for viewing by those who have taken the test. The geographic analysis tool 228 allows a user to analyze data, for example, survey responses, geographically, display the results of the survey in a geographically-coded map, and analyze the results of the survey using the geographic data. The forms application and development tool 230 allows a user to create multiple-step forms or other documents and to define an application flow or mapping that defines the path or course from one form to another. The data query tool 232 is designed to connect to a customer database, analyze the database to find desired correlations, and, based upon those correlations, make purchase suggestions to a consumer or potential consumer. Lastly, the menu tool 234 allows a user to create electronic menus and order forms, and provides mechanisms to accept online orders, make recommendations to consumers (based on previous orders), and electronically deliver consumer orders to a restaurant of interest.

Many of the sub-tools described above are based upon the form tool 222. Thus, using the development of a survey as an exemplary form, the architecture and design of the form tool 222 will be described first. As will become apparent, most of the remaining tools, or sub-tools, operate in a manner similar to the form tool 222, with some modifications and additions, and will be described further in subsequent paragraphs of this description.

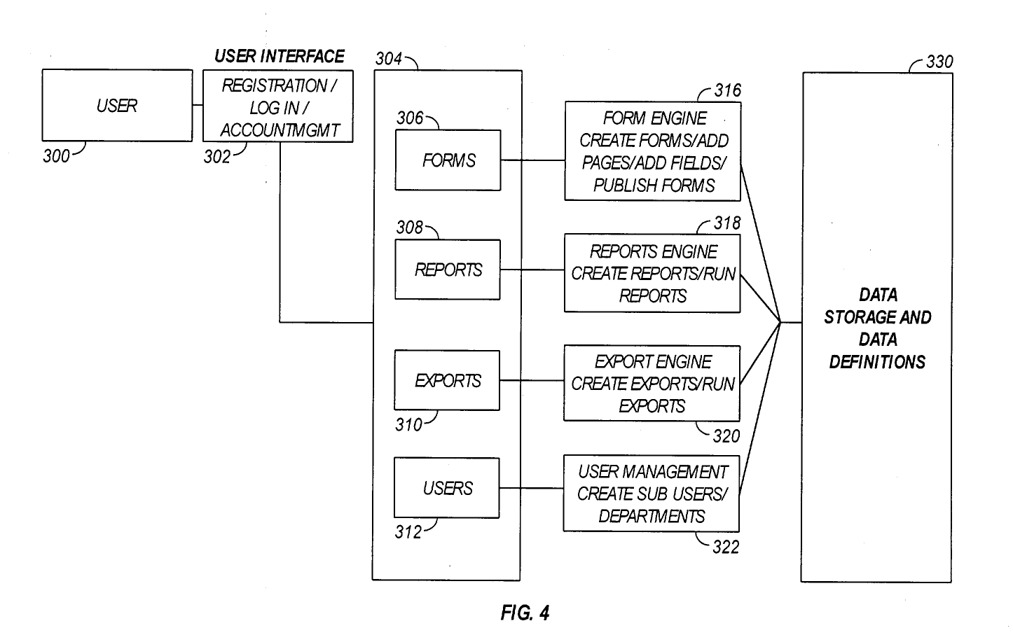

As best seen by reference to FIG. 4, a user 300 accesses the form tool 222 through a user interface 302, that may, for example, be presented in the window of a browser. In one embodiment, the user interface presents a login dialog box (not shown) or similar device that provides a mechanism for the user to enter security information (such as user name and password) and account information (to ensure division of forms and information for various projects and users). The user, assuming a successful login is achieved, is then presented with a main menu 304 that has a forms selection or option 306, a reports option 308, an exports option 310, and a users option 312. Each of these options, and the features associated with the options, is generated or driven by a corresponding engine, namely a form engine 316, a reports engine 318, an exports engine 320, and a user manage routine 322. Outputs from the engines 316-322 are stored in memory as data templates or definitions, shown schematically by box 330. It should be noted that terms such as “engine” and “routine” are used herein to broadly encompass portions of software that provide output for a given set of input parameters, software that applies rules to dynamic data, and the like.

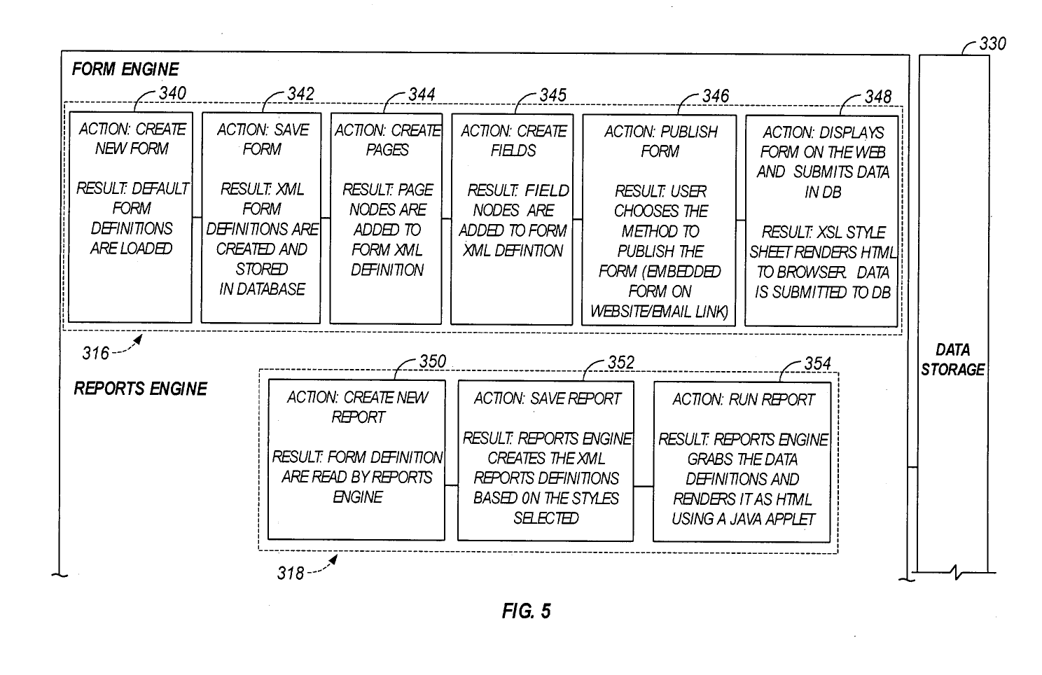

FIG. 5 illustrates additional features of the engines 316 and 318 for one embodiment of the invention. As shown, the form engine 316 has a number of user actions or options including a create new forms option 340, a save form option 342, a create pages option 344, a create fields option 345, a published form option 346, and a display form option 348. If the user selects the create new forms option 340, the form engine 316 loads a default form definition or design template from memory. The new form may then be modified by the user to reflect specific preferences. Preferably, the definitions or templates discussed herein are extensible markup language (“XML”) templates. If the user selects the save form option 342, the form engine 316 creates templates for the current form and stores those templates in an applicable database. If the user selects the create pages option 344, page nodes are added to the applicable form definitions or templates. If the user selects the create fields option 345, the form engine 316 adds field nodes to the applicable form templates. Selection of the published form option 346 causes the form engine 316 to provide a user with choices to publish the form such as embedding a URL or an e-mail link to the form. Selection of the display form option 348 causes the form engine 316 to render XML code. An extensible style language (“XSL”) style sheet is then applied to the XML code to generate the HTML code for displaying the form on a browser. In this embodiment, the form engine 316 acts as a design template rendering engine.

As also shown in FIG. 5, the reports engine 318 supports three user actions. When selected, the first of these, a create new report action 350, causes the reports engine to create the form template. The second of these, a save report action 352, causes the reports engine 318 to create a report template based on a style selected by the user from a predetermined group of styles. The last action, a run report action 354, causes the reports engine 318 to retrieve data templates associated with a current form and render the report in HTML code using a reporting script, which may be a Java Applet.

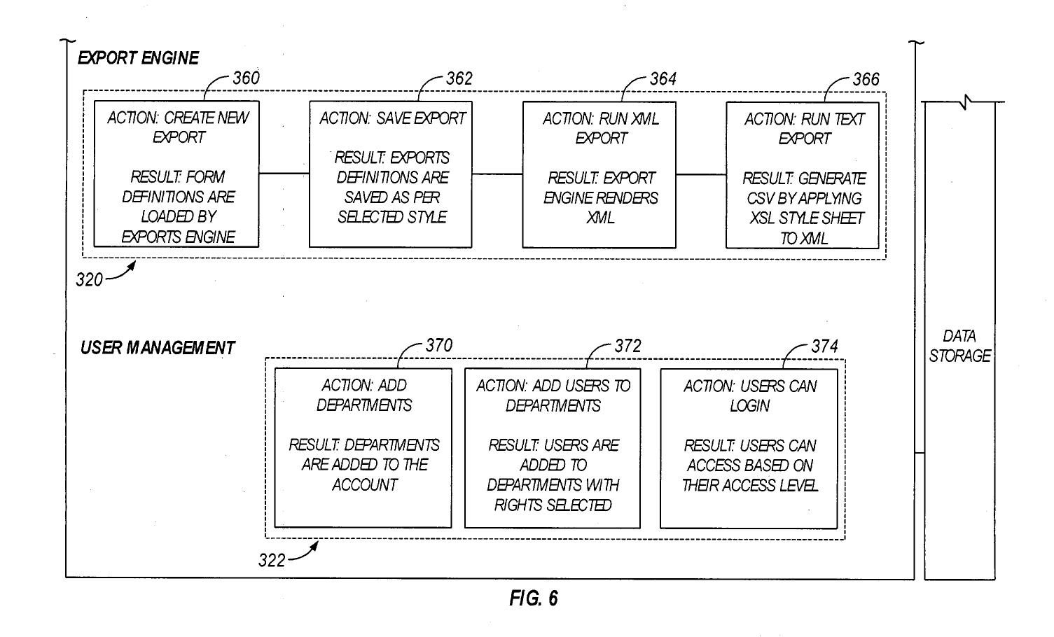

Illustrated in FIG. 6, the export engine 320 supports a create new export action 360, a save export action 362, a run export action 364, and a run text export action 366. The create new export action 360 causes form templates to be loaded from memory by the exports engine 320. The save export action 362 causes export definitions or templates to be saved based on a style selected by a user from a predetermined group of styles. The run report action 364 causes the export engine to render XML code. The run text export action 366 causes the export engine 320 to render the export in CSV format by applying one or more XSL style sheets to the rendered XML code.

In the exemplary embodiment shown, the user manage routine 322 supports an add departments action 370, an add users to departments action 372, and a users login action 374. The add departments action 370 allows segments, in the form of departments, to be added to an account. The add users to departments action 372 allows for the addition of users to a department and to specify the access level of each added user. The users login action 374 allows specified users to access an account according to the user's assigned access level.

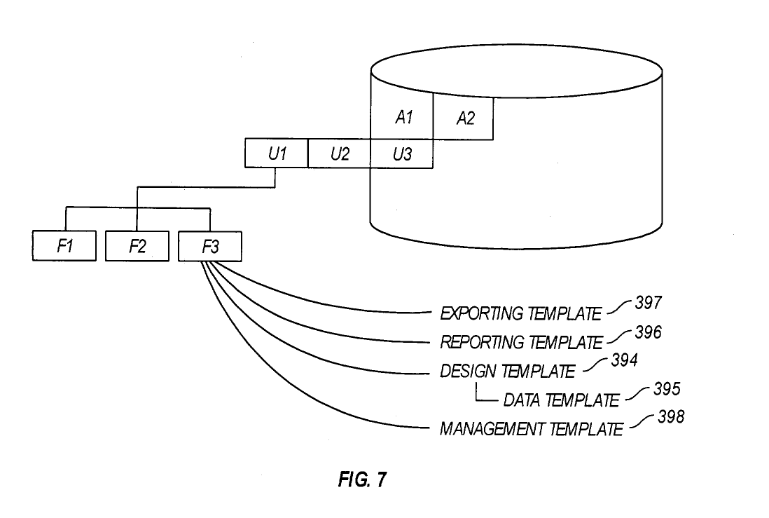

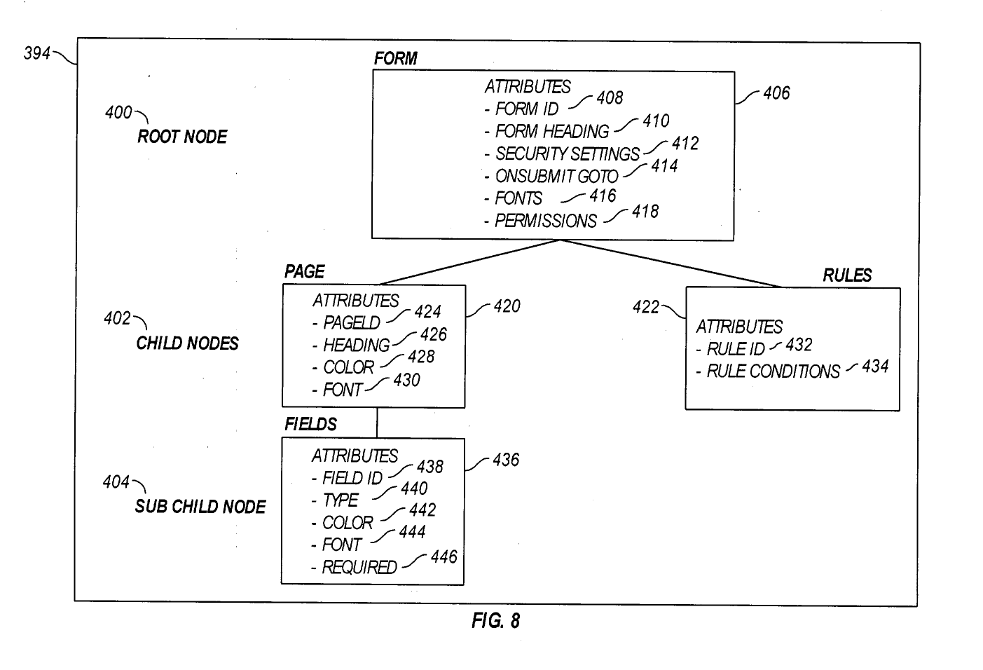

The above may be better understood by reference to FIG. 7 which illustrates one manner in which accounts and users are configured in one embodiment of the invention. Accounts (A1, A2, etc.) are assumed to be associated with enterprises (e.g., a company) and each account is assumed to have multiple users (U1, U2, U3, etc.). Each user is likely to have multiple forms (F1, F2, F3, etc.) and, as discussed, each form is based on a number of definitions or templates: a design template 394 (from which a data template 395 may be derived), a reporting template 396, an exporting template 397, and a management template 398.

FIG. 8 illustrates the architecture of a design template 394 suitable for use with embodiments of the invention. The design template 394 uses a hierarchical storage structure including a root node 400, one or more child nodes 402, and one or more sub child nodes 404. Each child nodes receives information from its parent. In embodiments of the invention, a design template 394 is a template that includes the design attributes of a form. In the design template 394, a form node 406 includes overall form attributes such as a form identifier or “ID” 408, a form heading 410, security settings 412, an OnSubmit Goto command 414, fonts 416, and a permission flag 418. For example, when a user creates a form, associates a destination URL with the form, and then submits the form, the OnSubmit Goto command 414 operates to link the user's browser to the associated URL for viewing the form. A page node 420 includes a page ID 424, a heading attribute 426, a color attribute 428, and a font attribute 430. The rules node 422 includes a rules ID 432 and a rules conditions attribute 434. A fields node 436 includes a field ID 438, a type attribute 440, a color attribute 442, a font attribute 444, and a required flag attribute 446.

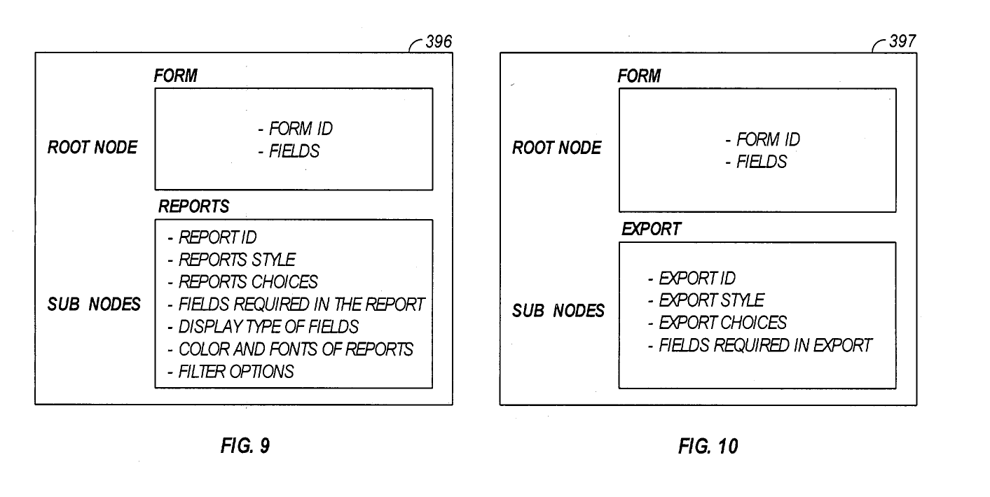

FIGS. 9 and 10 illustrate the reporting template 396 and exporting template 397 in additional detail. The structure of each of these templates is relatively similar to the structure of the design template 394 and, based on the discussion of the design template 394 and the information provided in FIGS. 9 and 10, should be apparent. Therefore, a detailed description of the templates 396 and 397 is not provided. It should also be noted that although a detailed diagram of the management template 398 is not provided, its structure is also similar and may be modified based on the management required for the application or user at hand. Preferably the management template provides status information such as an activation date, an expiration date, the number of responses, the date of the last response, and information regarding the expiration of the license the customer has to use the tool.

Having described much of the basic architecture of the form tool 222, additional information is now provided by way of a discussion of the pages or displays presented to a user during the creation of a form, which in the example provided is a survey.

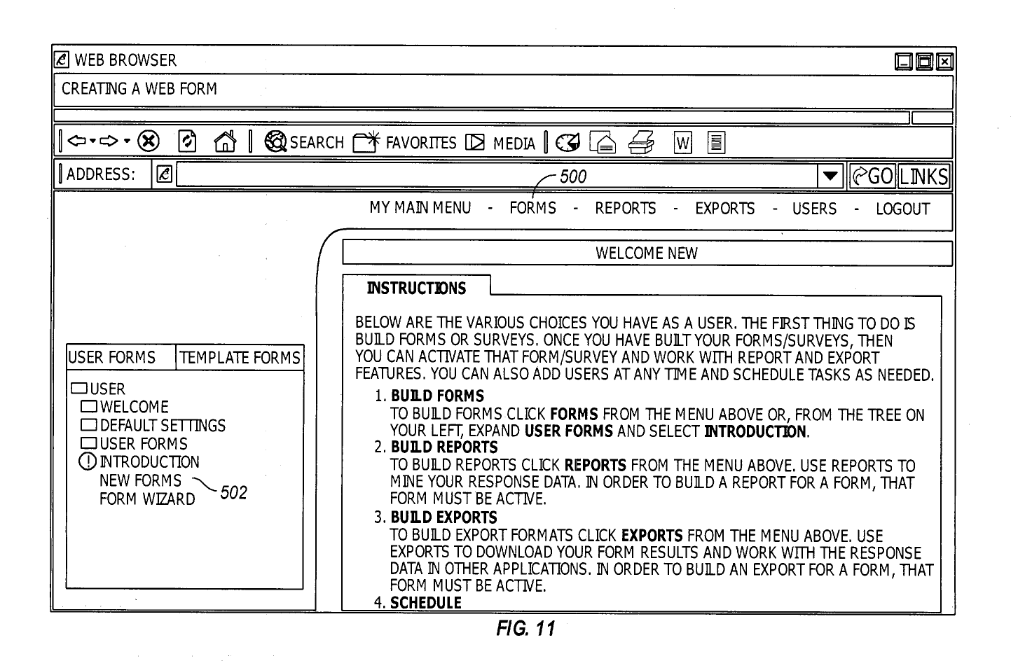

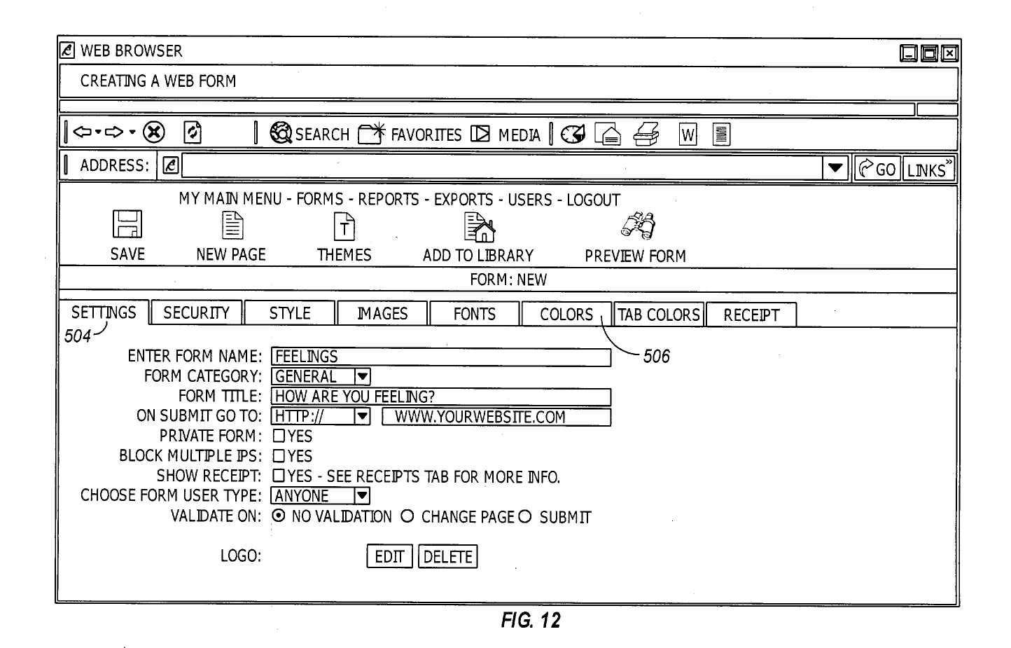

FIGS. 11 through 32 illustrate at least a portion of the output that a user stationed at a computer 100 might see on a display device 108 when invoking the form tool 222. It is to be understood that the illustrations are for exemplary purposes only and that the contents of which are not to be considered limiting. Furthermore, the invention may be implemented with additional features, such as form options and graphical tabs, which may not be shown or described in the drawings. FIG. 11 is an interface screen illustrating a first portion of a form creation process. One option provided to registered users is selection of a “Forms” menu icon 500 or “New Form” link 502. After selecting one of these options, the user is presented with the display shown in FIG. 12.

FIG. 12 illustrates a new form information input screen where the user may select from a plurality of graphical tabs representing options comprising functionality within the display window. The active tab shown in FIG. 12 is the “Settings” tab 504 and accepts user input. The input data shown in FIG. 12 as text, check box selection, “pull-down” menu selection, and radio button selection is merely exemplary and should not be considered limiting as the input entered depends on the user's preferences.

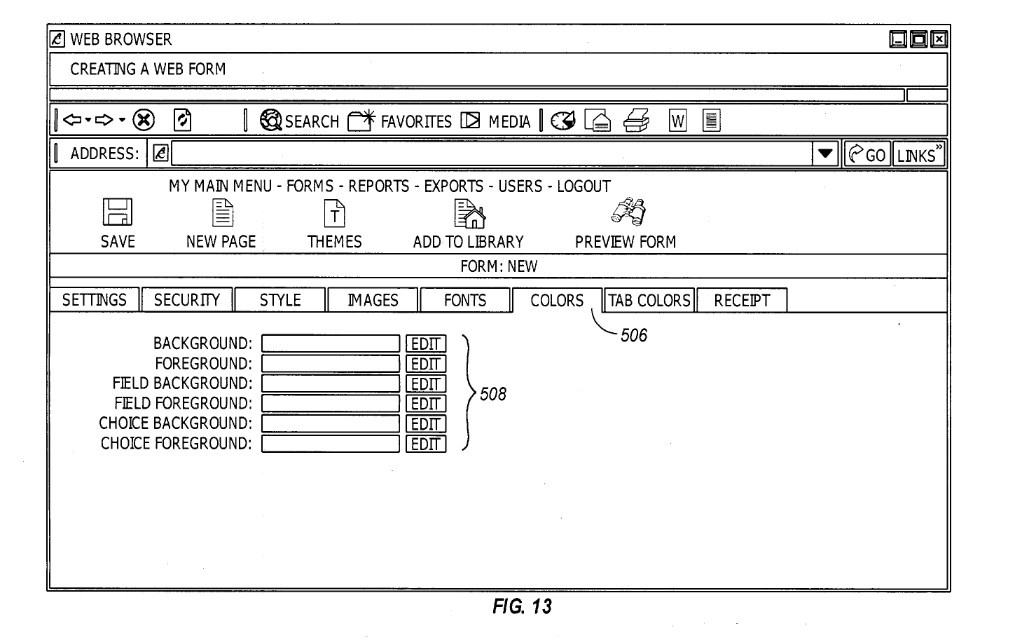

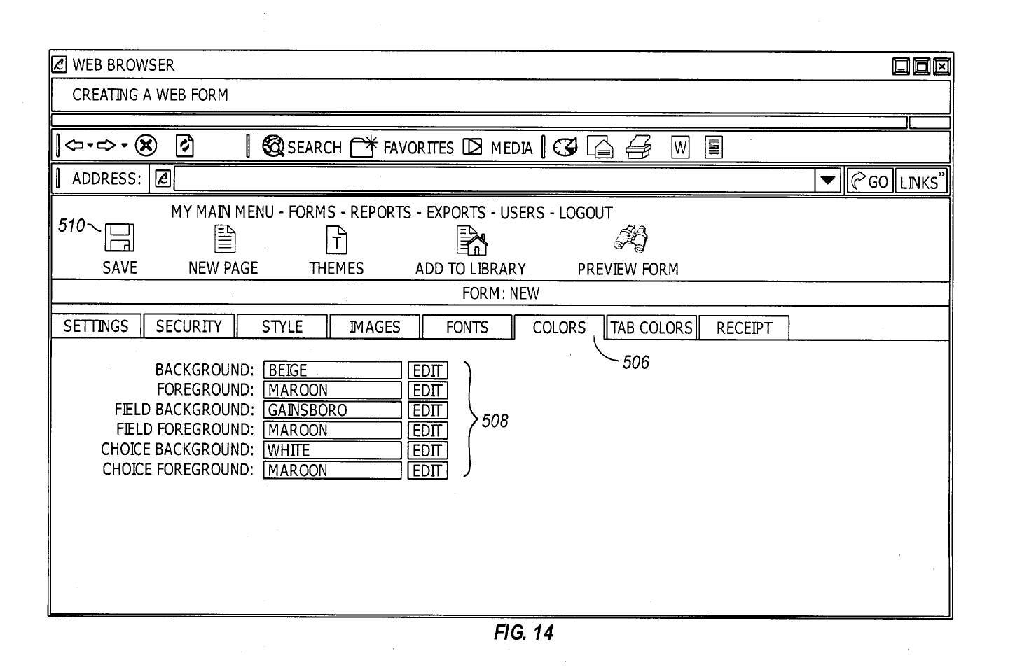

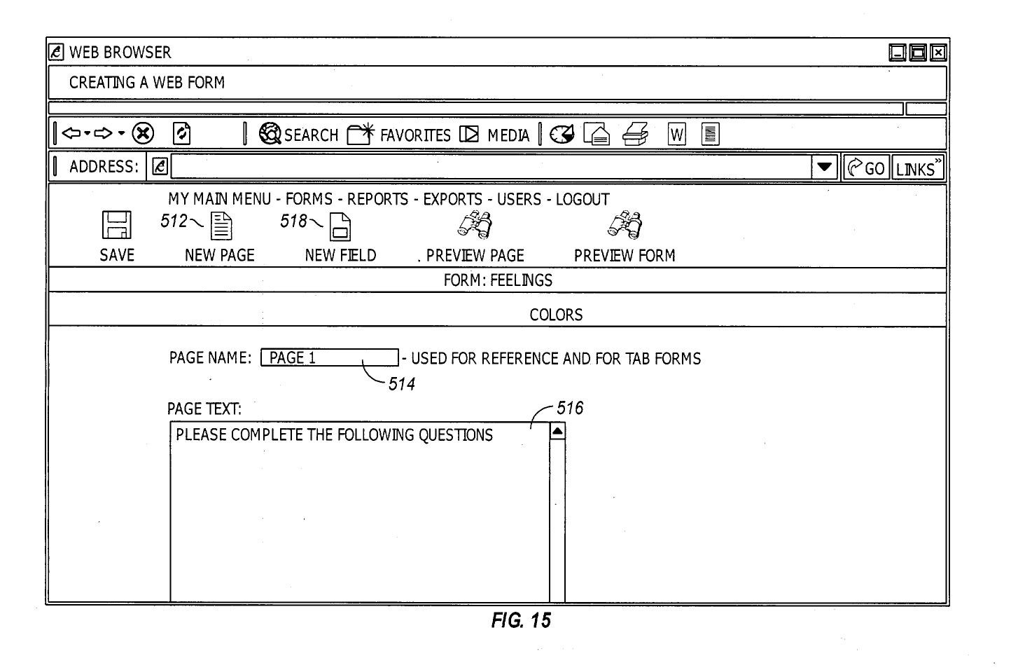

Selecting the “Colors” tab 506, causes the page in FIG. 13 to be shown. The page illustrates some of the editable color features provided by the tool. The user can select the intended field to modify by clicking one of a plurality of “Edit” buttons 508. Selection of an Edit button 508 presents a dialog window including a color pallet from which the user may choose a desired color. The Edit buttons 508 allow a user to modify the color of form components including foreground, field background, field foreground, choice background, and choice foreground. FIG. 14 shows another step in the form creation process whereby a save command is invoked by clicking on a “Save” icon 510. It should be noted that the save command is operable at multiple instances in the form creation process and that the plurality of graphical tabs, as illustrated in FIG. 11, are variably selectable in order and should not be limited to the depicted example.

FIG. 15 illustrates a portion of a display window comprising a “New Page” input interface. The user accesses this display window upon selection of the “New Page” icon 512. The input fields on this display includes a “Page Name” field 514 and a “Page Text” field 516. For example, the Page Name field 514 may be filled with a page number or other identifier and the Page Text field 516 may be filled with instructions or similar text. Typically the form is saved after completing the steps shown in FIG. 15 and an exemplary next step is to select the “New Field” icon 518.

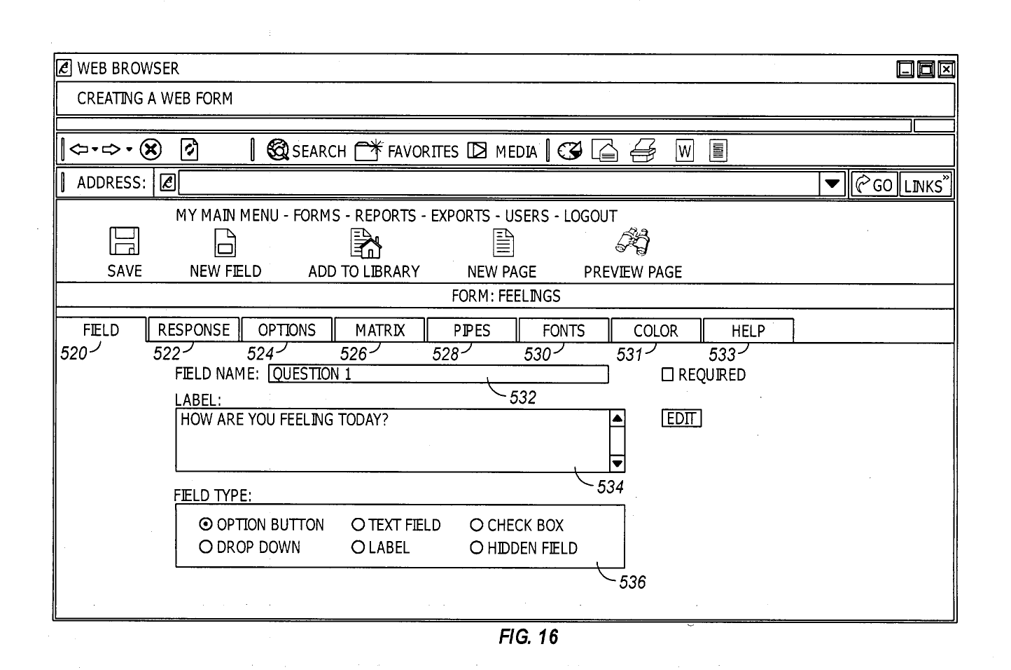

Selection of the New Field icon 518 presents the user with an input interface as shown in FIG. 16. The interface provides a number of options to the user. The options are presented in tabs including a “Field” tab 520, a “Response” tab 522, an “Options” tab 524, a “Matrix” tab 526, a “Pipes” tab 528, a “Fonts” tab 530, a “Color” tab 531, and a “Help” tab 533. Selection of the “Field” tab 520, presents a plurality of input data fields including “Field Name” 532, “Label” 534, and “Field Type” 536. As one example, the user may name the field as “Question 1” and make it a required field. The label could be entered as the text of a question and the field type set to an “Option button.”

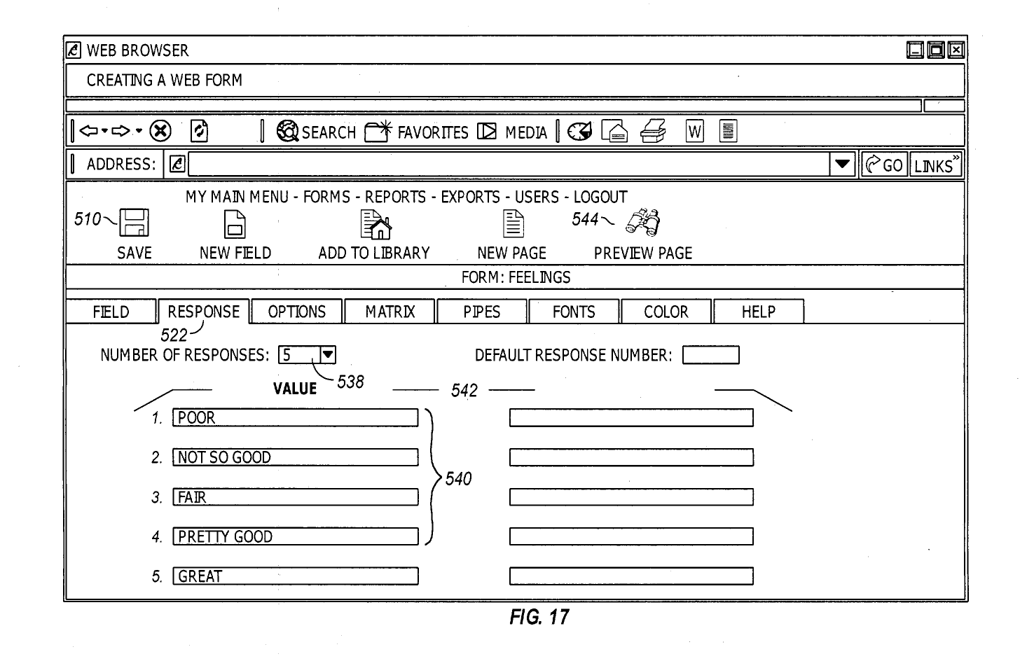

FIG. 17 illustrates the output displayed when a user selects a “Response” tab 522. The Response tab 522 includes a “Number of Responses” pulldown selection field 538 and a plurality of dialog boxes 540 that correspond to the number entered using the selection field 538. The dialog boxes provide input mechanisms for a user to enter values for each response. The input to the exemplary “Value” field 542 is user-defined text corresponding to a level of desired response. The input data may be saved after field modifications are finished by selecting the Save icon 510.

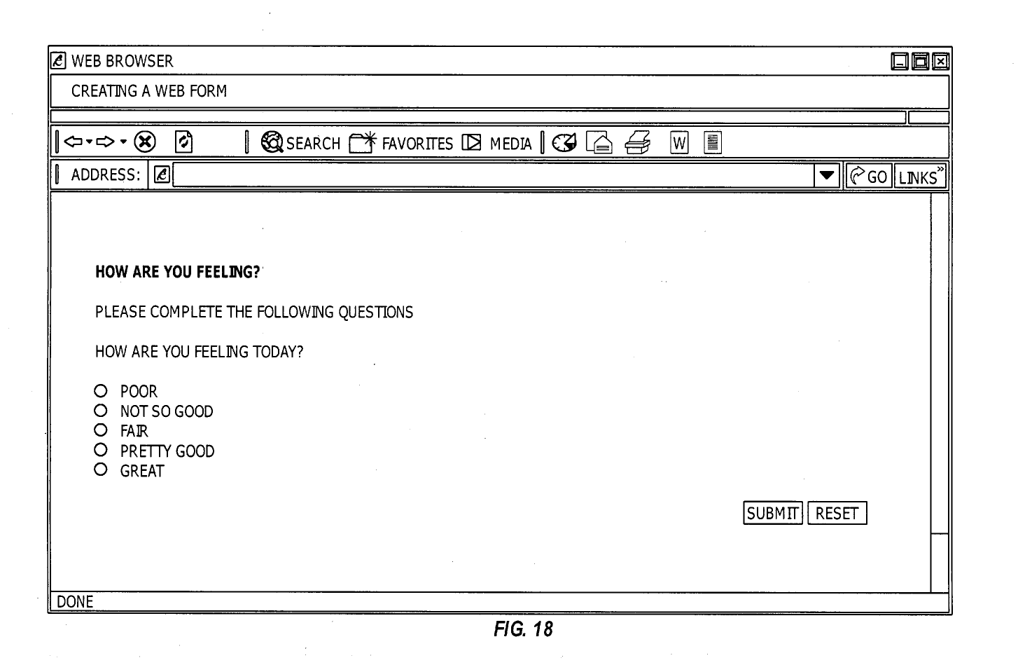

A preview image of the form may be obtained by selecting the “Preview Page” icon 544. FIG. 18 illustrates a portion of a display window that includes a preview of the sample form created in the process described in FIGS. 11 through 17. It should be noted that although not all of the tabs illustrated in the drawings are shown or described in detail, a subscriber of the automated form and data analysis tool, as shown in exemplary FIG. 3A, will have access to these and additional features.

The user data that is input to populate the fields in the figures discussed above is associated with a form development module 240 (FIG. 3B) of the form tool 222, which includes a design template 394 and a form engine 316. The design template 394 serves to preserve the formatting preferences set by the user including placement of text, placement of fields, color selection, font selection, images, and the general visual appearance of the form as determined by the user. The design template 394 also stores any rules that exist for implementing condition-based queries. A condition-based query may, for example, skip one or more questions, or initiate other functionality, depending on respondent data. Another function of the design template 394 is to maintain validation data that represents the preferred data field types. This validation data allows for verification of a correct field type during form generation such that the respondent information is in accordance with the design template 394 field type preference. Preferably, XML is used as the metalanguage for creation of the design template 394 and provides a basis for storage of the form preferences.

With reference to FIG. 3B, the form engine 316, of the form development module 240, is operable to read the information stored in design template 394. The form engine 316 processes information from the design template 394 and is capable of generating at least a portion of a form upon user initiation. In addition to the functionality shown in FIGS. 3B and 5, the form engine 316 may apply formatting, rules, validation, and other general form preferences when rendering a form. From the user's perspective, invoking a display function during the form creation process causes the form to be displayed, for example, on display device 108.

A form management module 250 (FIG. 3C) renders a created form operable on a network 204 whereby other clients 202 on the network 204 may access the form. Using the form management module 250, the user or form creator has options to assign functionality to one or more forms and to associate a form with a mode of publication such as email or web-based. Further description of the form management module 250 is provided below.

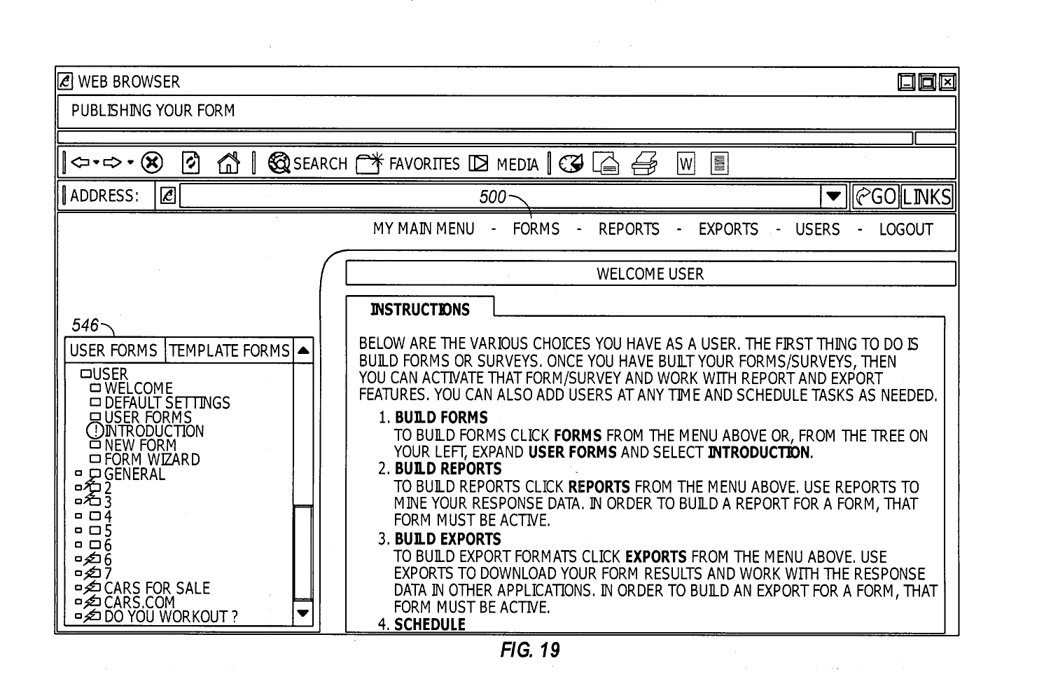

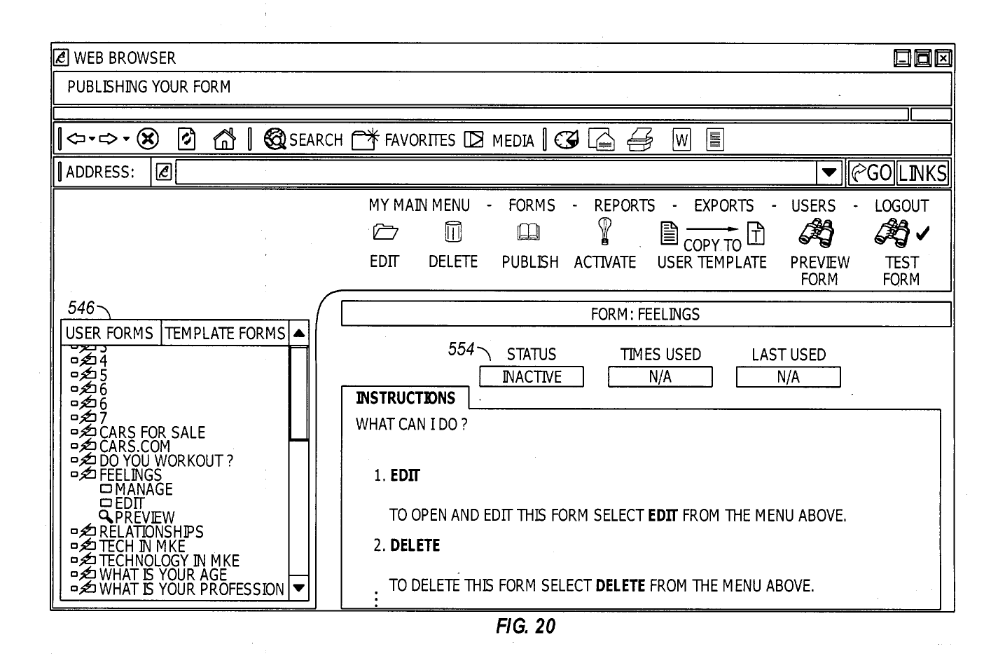

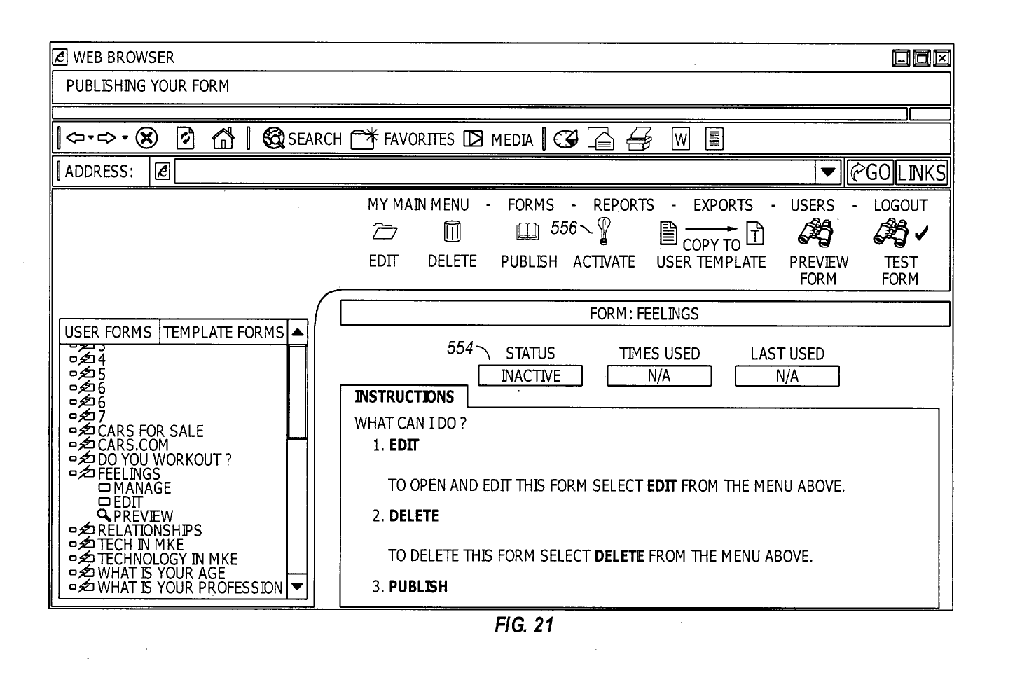

As described above, the interface window illustrated in FIG. 11 presents the user with a plurality of choices. One of the choices is to publish a form. This choice may be elected by selecting the “Forms” icon 500, as shown in FIG. 19. The selection of the “Forms” icon 500 generates a list 546 of available forms (that a user has previously created) on a portion of the display window as shown in FIGS. 19 and 20. The user selects the preferred form and the display then presents the user with a plurality of options associated with the selected form. The options shown in FIG. 20 include a “Manage” icon 548, an “Edit” icon 550, and a “Preview” icon 552. However, additional options are possible and may be implemented. In the present example, the user clicks on the “Manage” icon 548. If the subject form has not been published, the “Status” field 554 displays “Inactive,” as shown in FIGS. 20 and 21.

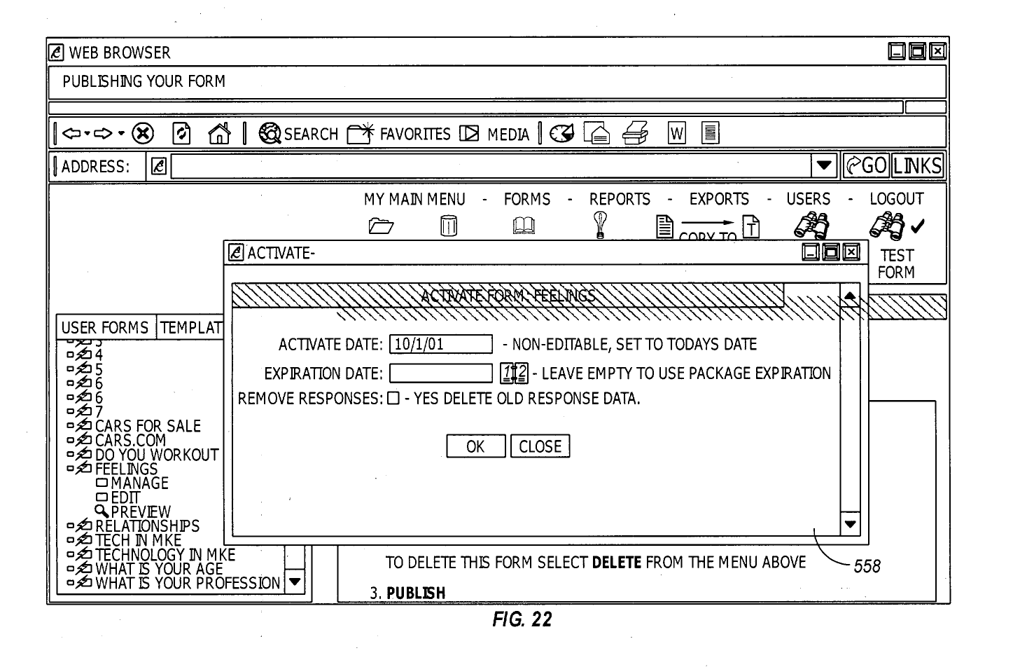

FIG. 21 illustrates multiple menu options that are displayed upon selection of the “Manage” icon 548. One option for further execution of the form publishing process is the selection of the “Activate” icon 556. Once the Activate icon 556 is selected, the user is presented with the page shown in FIG. 22. The page includes a dialog window 558 prompting the user for data field input corresponding to the activation date and expiration date of the form. The expiration date of the subscribed service is selectable for use as a form expiration date. The user then clicks the “OK” button, which causes the input dates to be stored.

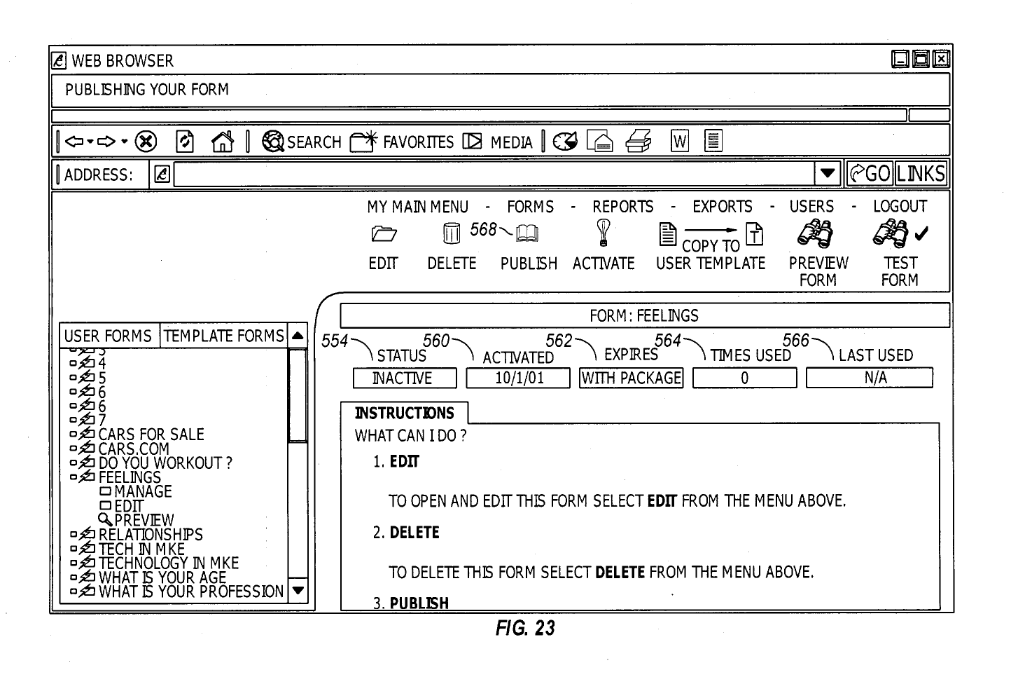

FIG. 23 depicts a first result of form activation. A multitude of form management attributes are presented to the user including a “status” tag 554, an “activation date” tag 560, an “expiration date” tag 562, a “times used” tag 564, and a “last used” tag 566. The information associated with each tag represents the result of the previous activation steps. The user selects a “Publish” icon 568 from an upper menu bar on the display window to continue the form publication process.

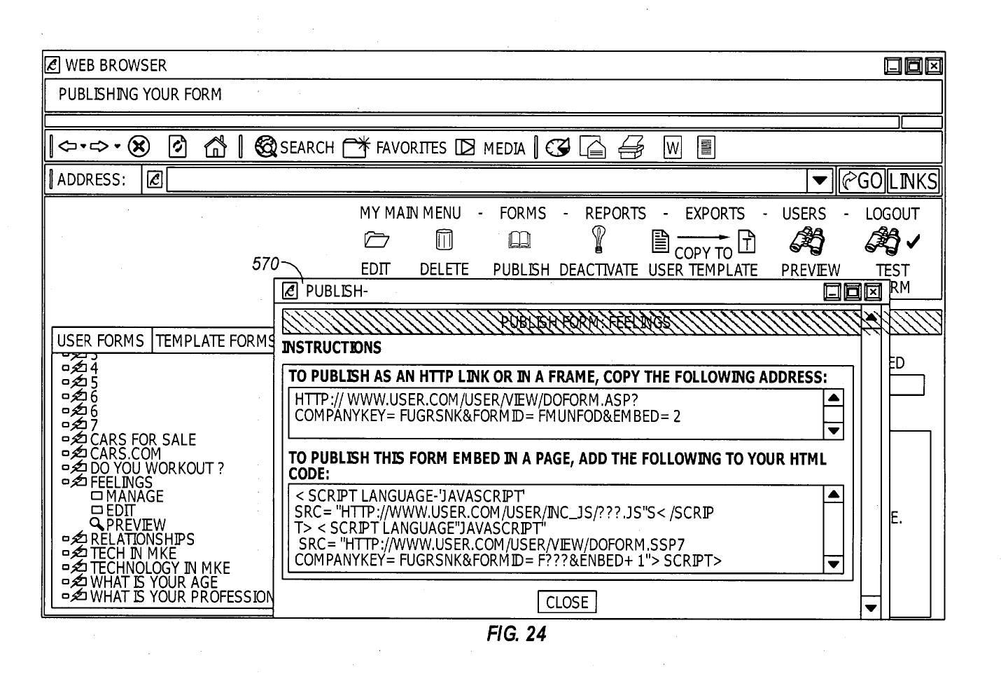

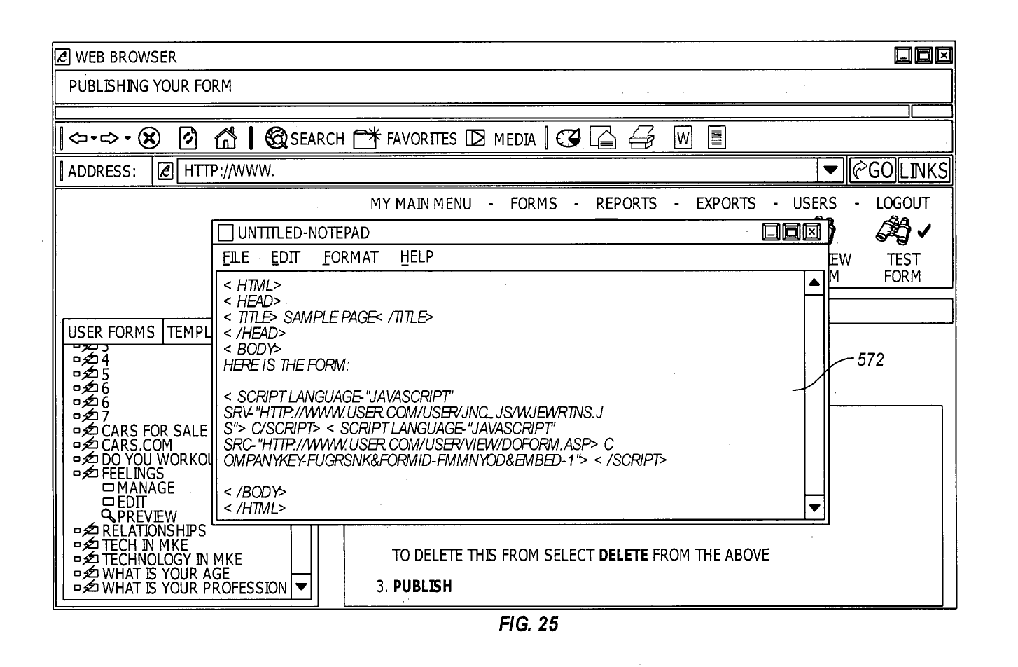

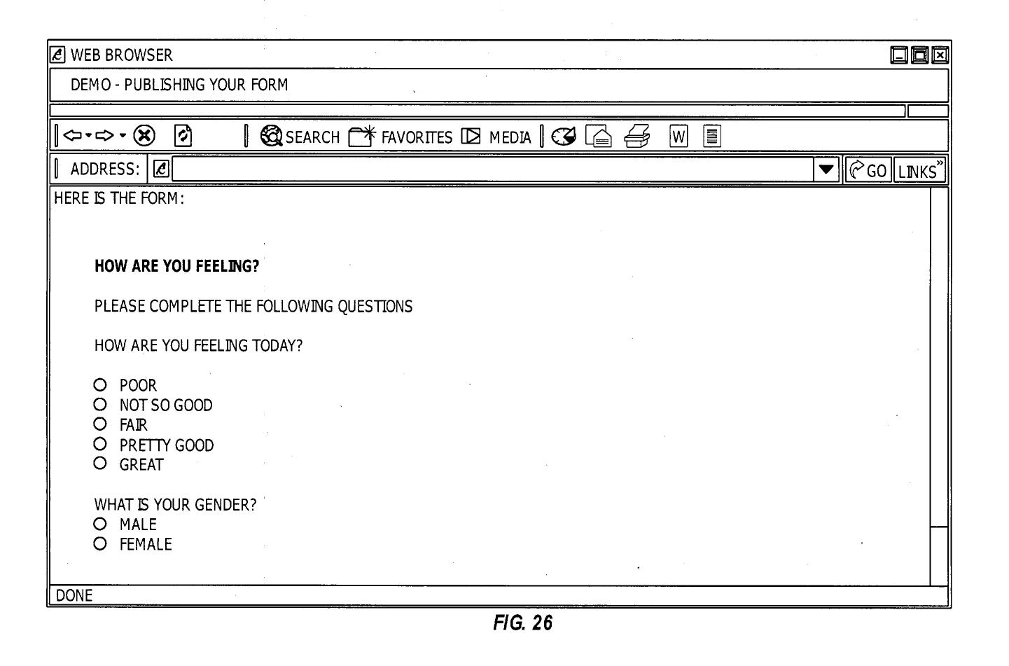

Selection of the “Publish” icon 568 presents the user with a publish form dialog window 570 shown in FIG. 24. The publish form dialog window 570 allows publication of the form as an hypertext transfer protocol (“HTTP”) link (or in a frame) and/or by embedding the form into an existing web page. For publication as an HTTP link (or in a frame), the invention generates a universal resource locator (“URL”) address that is linked to a location on a network. A URL distribution system allows clients, intending to view and/or respond to the form, access to the network location of the form. For publication by embedding the form into an existing web page, the form management module generates an appropriate HTML script that can be copied into an HTML file of an existing web-site. FIG. 25 and FIG. 26, respectively, show an exemplary HTML file 572 where a copy of the generated HTML script could be placed, and an example of a graphical display showing a portion of a published form.

As noted, the tool includes a management template 252 and a user management routine or manage routine 322. The management template 252 is operable to store data including form activation information, form expiration information, number of responses, and the date of the last received response.

The manage routine 322, of the form management module 250, provides functionality associated with the data stored in the management template 252. The manage routine 322 is capable of reading the management template 252 and generating an output in response to data stored in the management template 252. An exemplary function of the manage routine 322 is updating the number of received responses in the event that an additional response is present. As another example, the manage routine 322 may monitor the data representing dates indicating a data collection time period. The manage routine 322 is also operable to stop data collection after the data collection time period elapses.

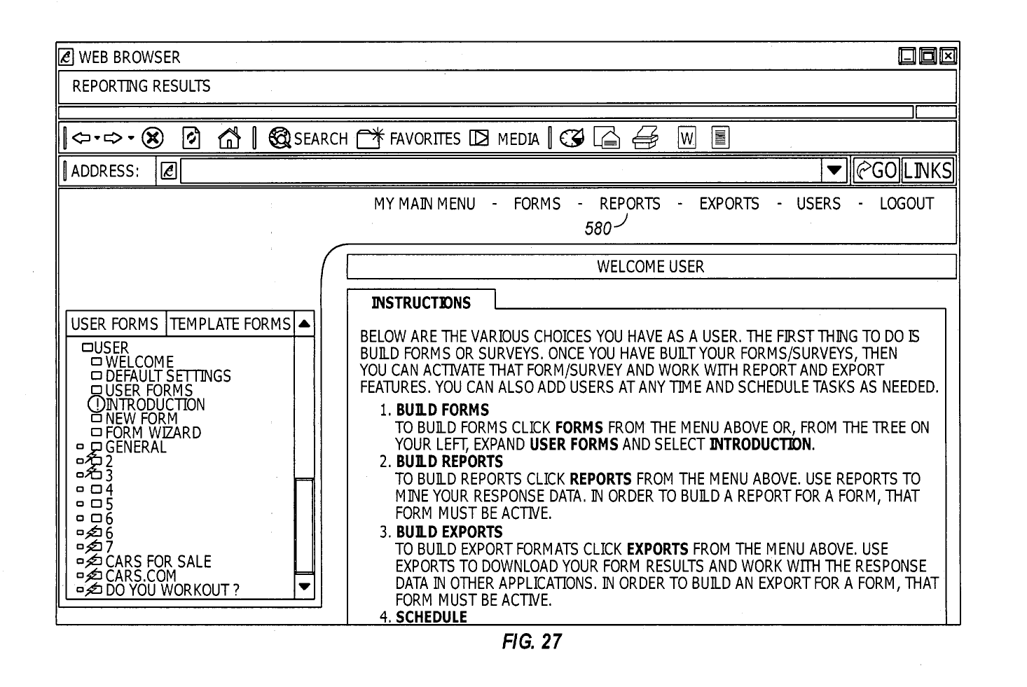

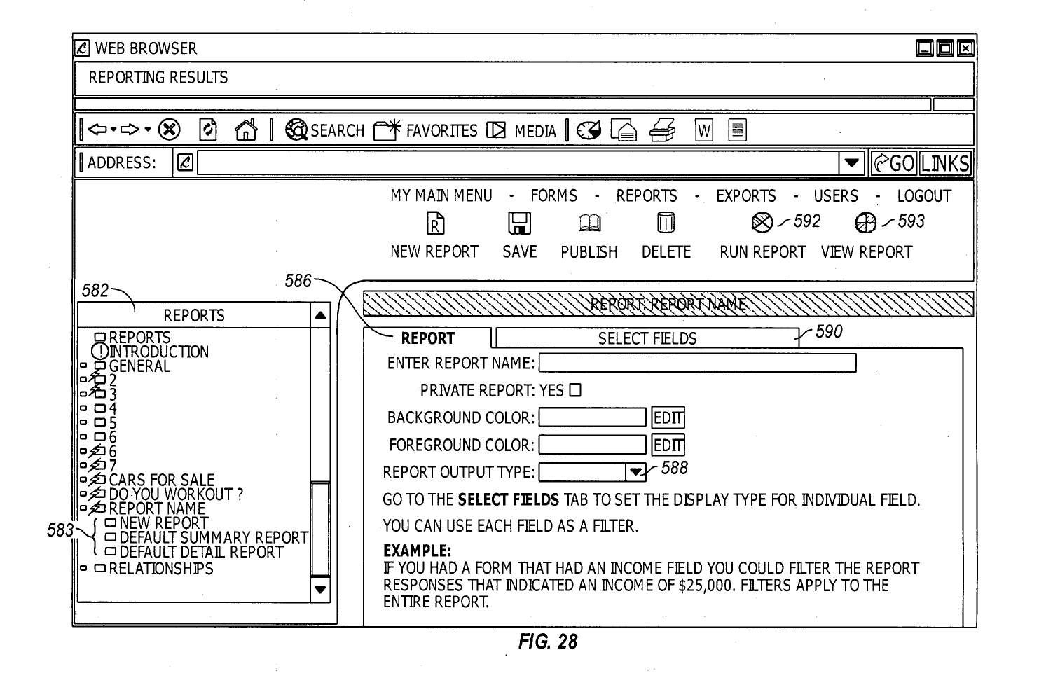

In another aspect of the invention, a report module 260 (FIG. 3D) allows a user to generate an analysis of the respondent data and view the results of the analysis on a display device 108. FIG. 27 illustrates a display presented to a user. The display has a plurality of menu choices. The reporting process begins with user selection of the “Reports” icon 580. Referring now to FIG. 28, the selection of the “Reports” icon 580 generates a list 582 of reportable forms. The user selects the preferred form and the display then presents the user with a plurality of functional options 583 associated with the selected form. The functional options may include a “New Report” option, a “Default Summary Report” option, and a “Default Detail Report” option. However, additional options may be provided. The user selects an option from the list 582 and, if desired, the user proceeds with the selection of the “New Report” icon 584. Selecting the “New Report” icon 584 activates a “Report” tab 586, which causes a plurality of input fields to be displayed. The user may populate the fields as desired. Specifically, a “Report Output Type” field 588 includes a plurality of report display options including a pie chart, bar chart, count, frequency distribution, detail, statistical analysis, minimum value, maximum value, median value, and standard deviation. The user can further modify the report format by choosing the “Select Fields” tab 590 and populating the desired fields. Clicking the “Save” icon 510 preserves the report format and user preferences. The selection of a “Run Report” icon 592 causes a report to be generated based on the data associated with the created form and the desired format of the report, and to be displayed to the screen. Alternatively, a “View Report” icon 593 may be selected to view a previously generated report (i.e., without having to wait for the respondent data to recompile). For example, after a report is generated for the first time, the result may be saved as a static HTML file. Subsequent requests to view the report may then be quickly executed by opening the static HTML file instead of regenerating or recompiling the data associated with the report.

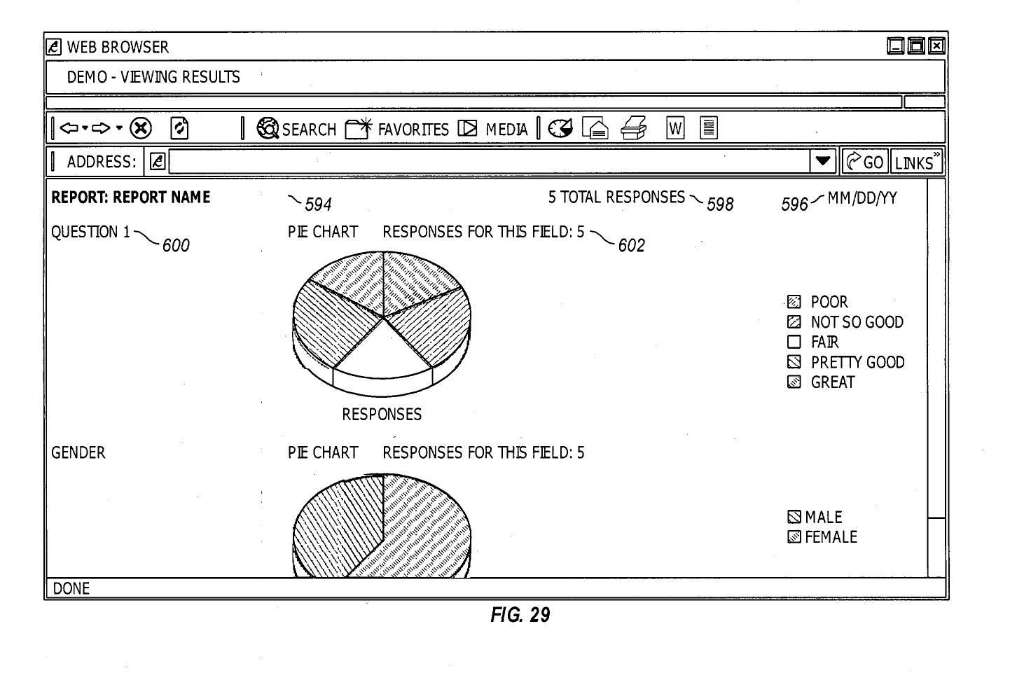

FIG. 29 illustrates a portion of an example report that includes a 3D pie chart corresponding to an analysis of respondent data. The exemplary report also includes a report title 594, a date 596, a total number of responses 598, a corresponding question title 600, and a per question response number 602. As described above, the data displayed in the report depends on how the user populates the fields presented in the reporting process and the display may vary from what is shown in FIG. 29.

With reference to FIG. 3D, the report module 260 may include a report data template 262, a report format template or reporting template 396, and a reporting engine 318. The report data template 262 may include data generated by the design template 394 and/or management template 398 including user defined preferences for data field types and/or activation and response tracking data. The reporting template 396 is operable to include data representative of report style, report choice, user defined fields intended for reporting, field display type, and general visual reporting preferences. The reporting engine 318 is operable to read the report data template and the reporting template 396. Information based on the report data template 262 and reporting template 396 are used by the reporting engine 318 to render at least a portion of the report to a display device 108. For example, the reporting engine 318 may create the XML definitions for the selected preferences and render the report as HTML using a Java Applet.

In another aspect of the invention, an export module 270 (FIG. 3E) is operable to generate a data file associated with data from a database. The export module 270 is operable to provide the data file to a client for analysis of respondent data by an application and/or for storage of the data file on a client computer 202. In the case of a scheduled export, the data file may be transferred from a hosting device to a client using commonly known transfer protocols such as file transfer protocol (“FTP”) or by electronic mail (e-mail). For non-scheduled exports initiated by a client, the data file may be transferred from the hosting device by other methods of network data transfer.

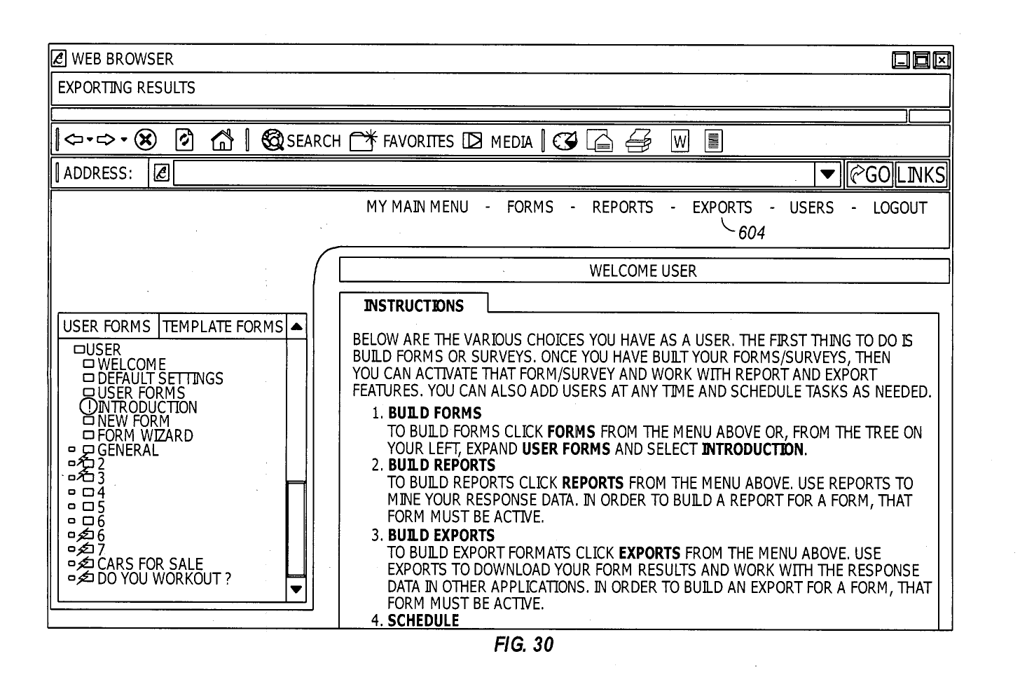

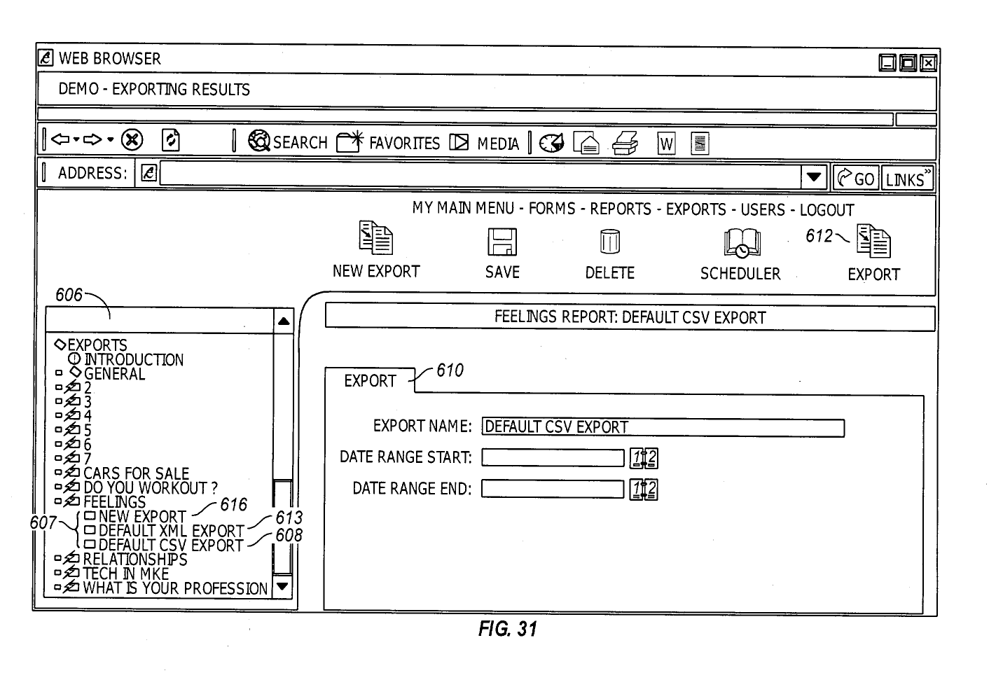

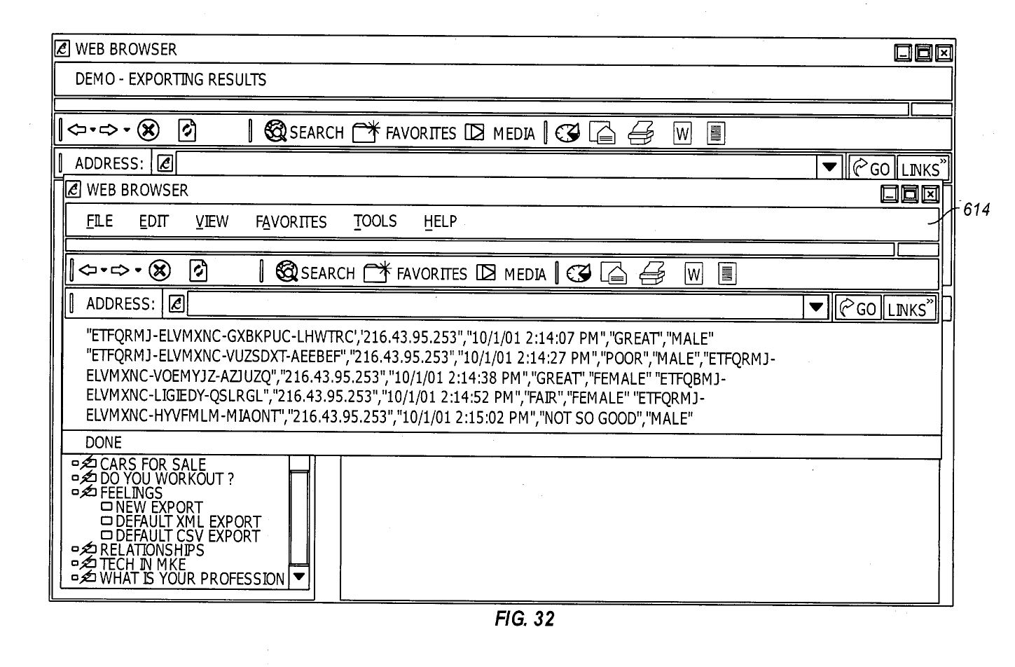

As shown in FIG. 30, a user may initiate the exporting process by selection of an “Exports” icon 604. Selection of the Exports icon 604 causes a form export list 606 to be generated on a portion of the display as shown in FIG. 31. As noted, the content of the exemplary illustrations, such as the exemplary export list 606, is not to be considered limiting in that the number of forms shown and names given are merely examples used for purposes of description. The user selects a preferred form and the display then presents the user with a plurality of exporting options 607 associated with the selected form. The exporting options may include a “New Export,” “Default XML Export,” or “Default CSV Export.” Selection of “Default CSV Export” icon 608 presents the user with a graphical “Export” tab 610 having a plurality of input fields. The user may populate the fields with data including a name for the export file, a date range start, and a data range end. Selection of the “Default XML Export” icon 613 presents the user with a graphical “Export” tab 610 that includes similar options. Selection of the “New Export” icon 616 presents the user with a plurality of graphical tabs (not shown) including an “Exports” tab, an “Options” tab, and a “Select Fields” tab. Once the preferred exporting format has been chosen and the associated input fields on the graphical tabs have been populated, the user continues the exporting process by selecting an “Export” icon 612. FIG. 32 illustrates an interface window 614 having data formatted in the selected exporting option.

The export module 270 (FIG. 3E) may include an export data template 272, an export format template or exporting template 397, an exporting engine 320, and an export data file 274. The export data template 272 may be at least partially generated using information in the design template 394, and includes exporting definitions and respondent data types to be exported according to a user request. The exporting template 397 may include additional exporting preferences such as fields required in the export, the export style, and export choices. In the embodiment described, the export style or format may include a comma separated value (“CSV”) or an XML format. The exporting engine 320 is operable to read the export data template 272 and the exporting template 397, and render an export data file 274. For example, the exporting engine 320 may render XML code or a text file by applying an XSL style sheet to the XML code. In another embodiment of the invention, a scheduled recurrence of an export data file 274 transfer from a hosting computer database to a client computer database may be set by the user. As described earlier, the data file transfer methods for scheduled transfers may include FTP and electronic mail (e-mail).

As noted, embodiments of the exemplary automated form and data analysis tool 220 include various sub-tools. Further description of the feedback tool 224, online testing tool 226, geographic analysis tool 228, and data query tool 232 is now provided.

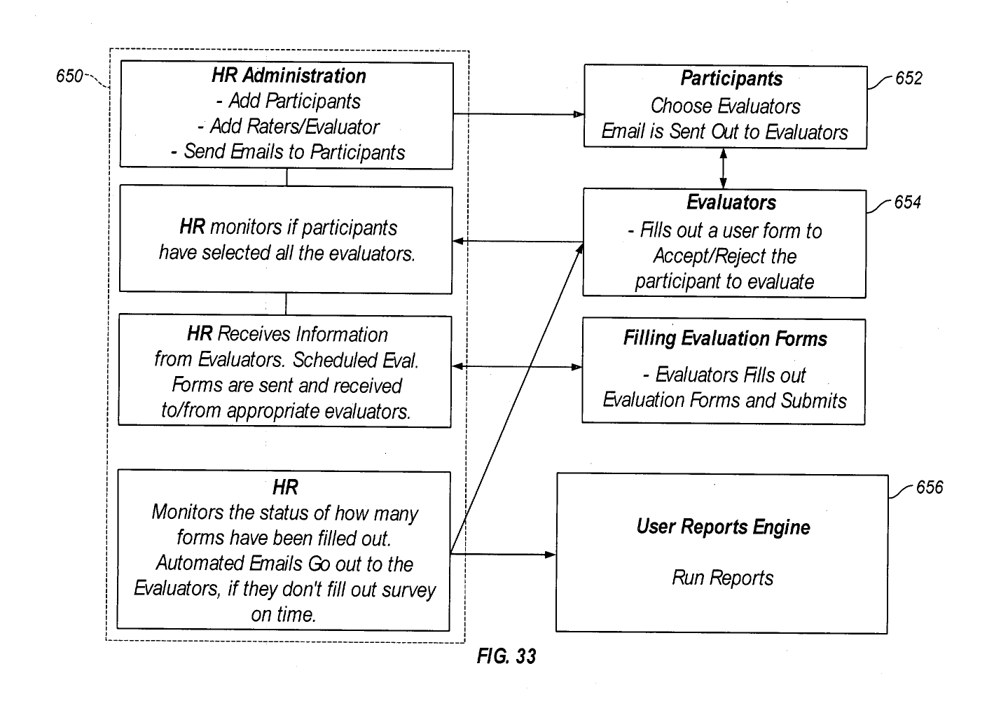

FIG. 33 illustrates a flow chart architecture of one embodiment of the feedback tool 224. The feedback tool 224 may be employed, for example, by a human resources (“HR”) department 650 intending to evaluate a participant or participants 652 by providing evaluation forms to one or more evaluators 654. The exemplary feedback process begins with the creation of an appropriate feedback form using the form tool 222. Selected participants 652 are notified to select their evaluators 654. The evaluators 654 either accept or decline participation in the feedback process by completing an electronic participation form. Upon completion, the form may be submitted or returned to the HR department 650. The accepting evaluators 654 then receive a scheduled evaluation form, created by the form tool 222, which is completed and submitted. The evaluation form, for example, may include input fields representing a series of employee rating questions. The participation and evaluation forms are distributed using a URL link in an email or posted on a web-site by a hosting computer that is remote to, in this example, the HR department 650. The evaluators 654, having appropriate authorization, access and submit the evaluation form. In accordance with other embodiments of the invention, respondent data is stored in a database on a hosting computer. HR department 650 receives notification of how many forms have been completed and the feedback tool 224 is operable to automatically notify evaluators 654 in the event an evaluation form is not submitted within a set period of time. A reports engine 656 of the feedback tool 224 is operable to generate data analyses based on form creation, data, and style preferences as described earlier.

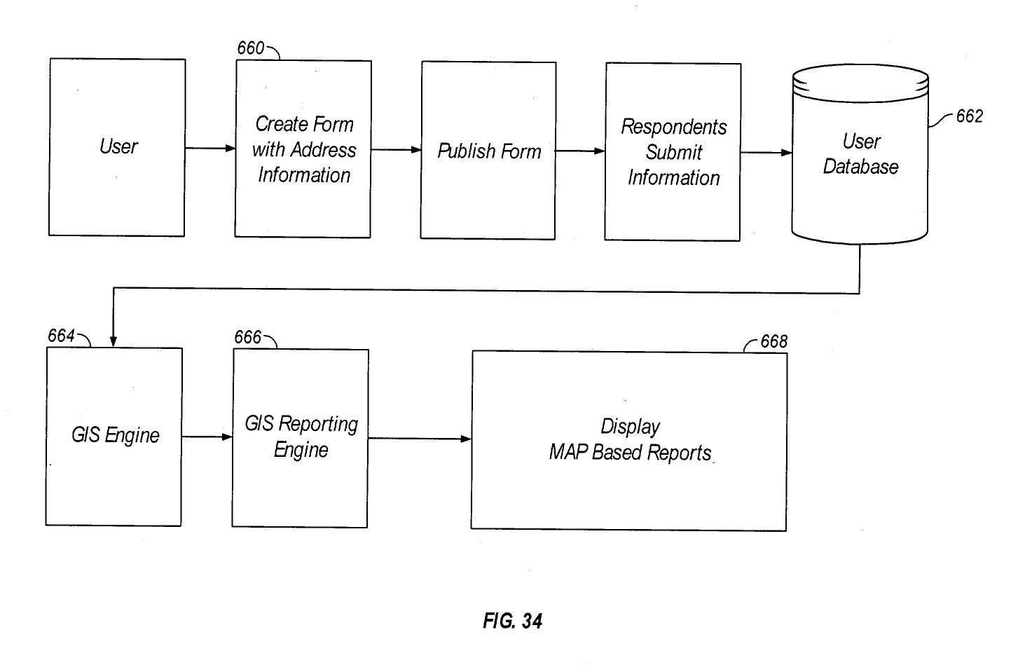

Another embodiment of the invention includes a geographic analysis tool 228. In the example illustrated in FIG. 34, the analysis tool 228 allows a user to create a form or survey 660 which includes input fields associated with respondent address information. The form 660 is published and respondent information, including address information, is stored in a corresponding database 662. A geographic information system (“GIS”) engine 664 is operable to read the database 662 and assign a corresponding latitude and longitude coordinate with the address of each respondent. A GIS reporting engine 666 is operable to receive the geographic information from the GIS engine 664. Upon user initiation, the GIS reporting engine 666 generates a geographical-based report that may be displayed as a map with indications of the relative location of the survey respondents. The GIS reporting engine 666 is operable to render the report on a display 668, which may be similar to the exemplary display device 108. In addition, the analysis tool 228 processes non-linear attitudinal data that may not be described by numbers. As one example, Law enforcement agencies may implement the analysis tool 228 to map out crime patterns for desired geographic areas. Police stations and individual patrol cars may identify, based on the real-time updates using the analysis tool 228, areas that need more personnel or additional patrol units. Another exemplary application of the analysis tool 228 includes locating bank branches and automated teller machine (“ATM”) stations. In such an application, the analysis tool 228 may be implemented to profile current banking customers based on, for example, account size and transaction activity, create models to aid in marketing campaigns, and search for strategic branch and ATM locations. Further, the analysis tool 228 may combine the profiled customer data and demographic characteristics of potential branch and ATM locations to provide conclusions regarding potential commercial success of those geographic locations.

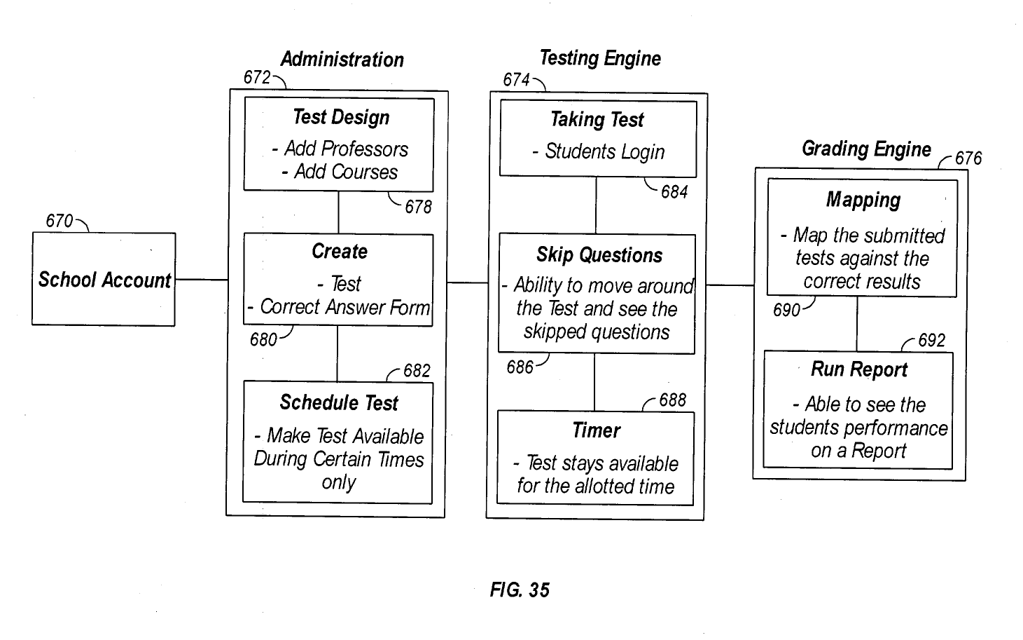

With reference again to FIG. 3, the online testing tool 226 generally allows a user to create, distribute, administer, and grade examinations or tests, and then post the results for viewing by those who have taken the test. FIG. 35 illustrates an example of an academic-based application of the online testing tool 226. The online testing tool 226 includes a school account 670, an administration module 672, a testing engine 674, and a grading engine 676. The user activates a relevant school account 670 and may access the administration module 672. The module 672 includes a test design function 678, test creation function 680, and test scheduling function 682. The test design function 678 allows users to associate a particular test or exam with appropriate teachers or Professors and/or courses. Using form tool 222, the user creates the exam and correct answer form based on test design criteria. The test scheduling function 682 may restrict access to the online exam before a predetermined “starting” time. The testing engine 674 includes a testing function 684, a “Skip Questions” function 686, and a timing function 688. The testing function 684 allows students, authorized to receive the exam, to “login” to the hosting web-site. The skip questions function 686 allows students to skip questions without submitting them, move to different questions within the online exam, and then return to those questions that were skipped. In another embodiment of the invention, the testing engine 674 is operable to alert a student attempting to submit an exam for which questions have been skipped and/or unanswered.

The timing function 688 is operable to restrict the amount of time the exam is available to recipients and to automatically submit the recipient's exam, regardless of their progress, after a predetermined amount of time. In the embodiment shown, the grading engine 676 includes a mapping function 690, and a reports function 692. The grading engine 676 is operable to read data from the hosting database associated with exam input field data. The mapping function 690 generates a comparison between the input field data and the correct answer data created in the administration module 672. The results, or grade, of an exam may be reported by a reports function 692. The reporting process, similar to previously described embodiments of the form tool 222, allows students to view their exam performance in a plurality of reporting formats.

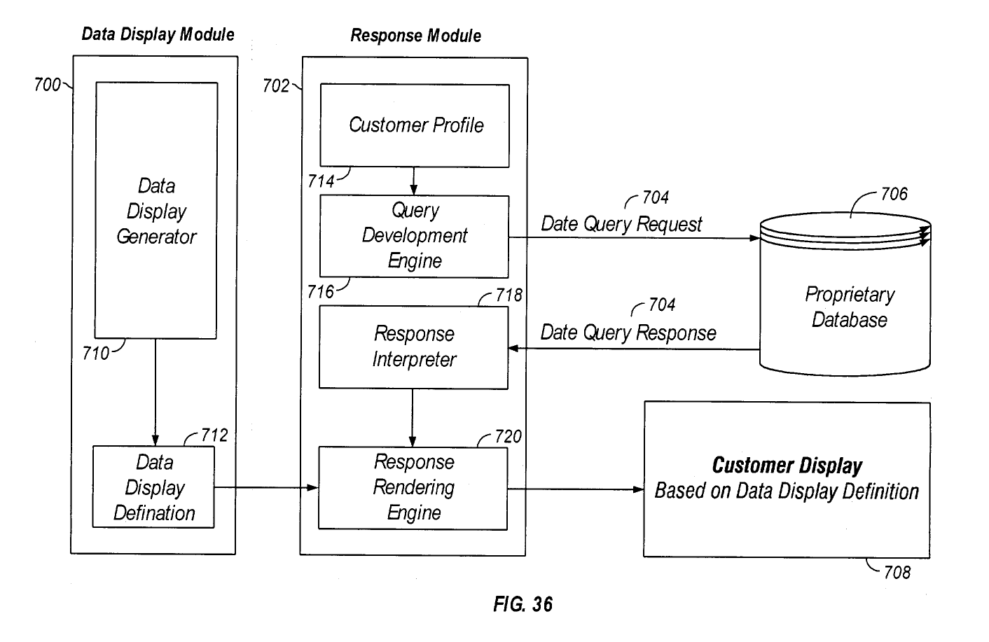

FIG. 36 illustrates an architecture of the data query tool 232 including a data display module 700, a response module 702, a data query link 704 to a database 706 (which typically holds or contains confidential information of the user), and a customer display 708. The data display module 700 includes a data display generator 710 and a data display definition or template 712. The user, in this example a business entity, subscribes to the data query tool 232 and uses the data display generator 710 to define custom graphical and field display formats for the surveys and forms created to show specific products and/or services. These display formats are stored in the data display definition or template 712. Information from the data display template 712 may be read by the response module 702. The response module 702 includes a customer profile database 714, a query development engine 716, a response interpreter 718, and a response rendering engine 720. One example of the invention may include the user having a form hosted on a web-site that is linked to a consumer or customer profile database 714. The respondent data is stored in the profile database 714 as the customer populates the form input fields. The query development engine 716 is operable to extract information from the profile database 714 and to generate a structured query language (“SQL”) based instruction. This SQL-based instruction is transmitted over the data query link 704 and includes information to query the user's database 706. The link 704 may include, for example, a network communications path between a server database of the invention and a database 706 of the user.

The response interpreter 718 receives the data query response signal from the database 706. The response rendering engine 720 receives information from the response interpreter 718 and data display template 712, and provides an output to the customer display 708. The customer display 708 may be similar to the display device 108 of computer 100. In one example, the data received by the response interpreter 718 may be representative of products and/or services that the user would like to offer the customer for sale, based on the data input to the customer profile database 714: The query development engine 716 and response interpreter 718 provide a mechanism for connecting to a database 706 with the intention of querying and retrieving proprietary information that may be relevant to a customer profile. The data display template 712 is used by the response rendering engine 720 to display the related proprietary data in a format defined by the user.

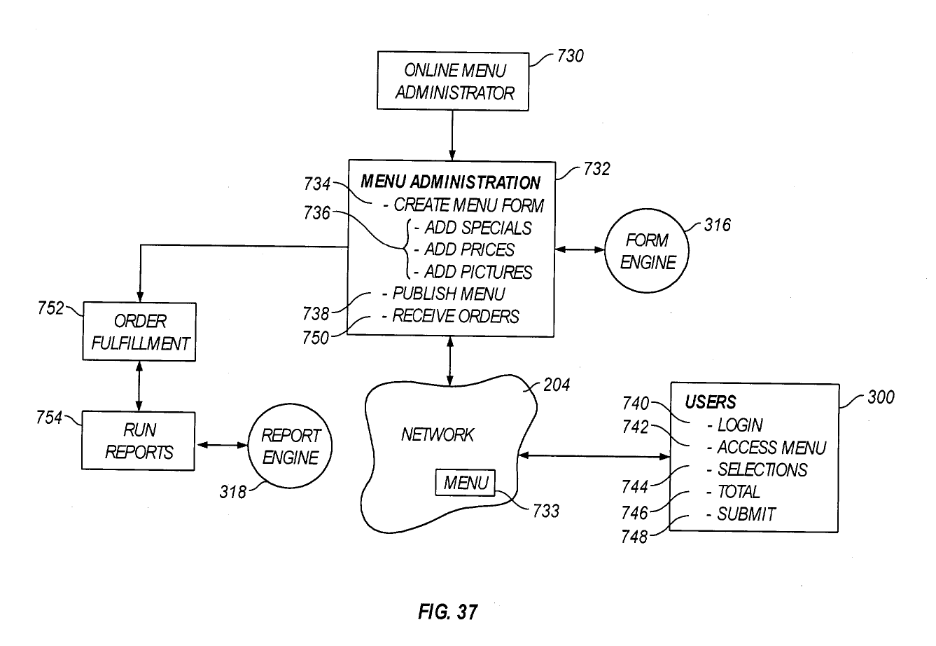

FIG. 37 illustrates one embodiment of the menu tool 234 that allows an administrator 730, such as a restaurant or business owner, to oversee an administration module 732. The module 732 may include the form tool 222 to create, distribute, and collect menu orders submitted by a customer or user 300. As one example, the administrator 730 subscribing to the menu tool 234 may access the administration module 732 to create an electronic order form or menu 733 at a step 734. As noted above, the creation process may utilize the form tool 222 including the form engine 316. The administrator 730 may create the menu 733 and incorporate menu attributes 736 such as daily specials, pictures, and prices. Upon creation of the menu 733, shown as step 738, the administrator 730 may publish the menu 733 on the network 204, such as the Internet, a local area network, or the like, whereby a customer or user 300 may access the menu 733. An exemplary interaction between the user 300 and the published menu 733 includes a login step 740 where the user may connect to the network 204. The user may then access the published menu 733 at a step 742 by, for example, using a search engine to locate the restaurant of interest or entering a URL that was previously sent to the user. Once completing the menu access step 742, the user 300 will preferably make menu selections at a step 744, whereby text or pictorial items included with the published menu 733 are selected using one or more of the field input options provided with the tool 200 including radio buttons, text entry, drop lists, etc. For example, the user 300 may click a menu icon to indicate selection of an item and input the desired quantity of that item into a text field. When the user 300 finishes making selections, a totaling step 746 is performed to calculate the individual price for each selected item, including those of multiple quantity, and present the user 300 with the total price for the selections made. The user 300 preferably has the option to add or remove items to/from the order and re-total the price. When satisfied with the order, the user 300 may initiate a submit step 748, whereby the order is received by the administration module 732 at a step 750. The submit step 748 may include email or web-site submission, fax, or other alternative methods of submission. Once the administration module 732 receives the submitted order, it is processed for fulfillment at a step 752. The fulfillment process may include a report step 754 using the report engine 318 as described above. For example, the report generated with the order may be printed or electronically viewed by restaurant staff, such as on the display 108, whereby the items in the order report may be prepared for delivery to the user 300.

In one embodiment, the menu tool 234 allows users to place an order such that the order is ready when the user arrives at the fulfillment destination. In other embodiments, the user may print the order and physically deliver the request upon arrival. Moreover, some embodiments menu tool 234 include the option to submit a payment with the order, such as using a credit card or an electronic funds transfer from a bank account, whereby the order total may be debited from the submitted account upon fulfillment or be used to reserve the order until delivery. In addition, order fulfillment may include shipping the items to the user having placed the order or electronically delivering the items using, for example, email. In other embodiments, the menu tool 234 is operable to store information in a database, such as database 330 (FIG. 4), based on user order histories for businesses subscribing to the menu tool 234 and, upon subsequent access to those menus by the same user 300, the menu tool 234 is operable to query the database 330 (FIG. 4) and provide order suggestions to the user 300 based on one or more previous orders.

As can be seen from the above description, the invention provides an automated form and data analysis tool as well as other tools. Various features of the invention are set forth in the appended claims.

1. A form tool comprising:
a form development module having
a design template; and
a form engine;
a form management module;
a report module; and
an export module.

2. A form tool as claimed in claim 1, wherein the design template includes a plurality of nodes.

3. A form tool as claimed in claim 1, wherein the design template is written in extensible markup language.

4. A form tool as claimed in claim 1, wherein the design template includes data representative of form options.

5. A form tool as claimed in claim 1, wherein the design template includes data representative of rules.

6. A form tool as claimed in claim 1, wherein the design template includes data for validation.

7. A form tool as claimed in claim 1, wherein the form engine is operable to read the design template.

8. A form tool as claimed in claim 7, wherein the form engine generates an output that causes a display device to display a form.

9. A form tool as claimed in claim 1, wherein the form tool is operable to process Extensible Markup Language code.

10. A form tool as claimed in claim 1, wherein the form management module includes
a management template; and
a manage routine.

11. A form tool as claimed in claim 10, wherein the management template includes a plurality of nodes.

12. A form tool as claimed in claim 10, wherein the management template includes data representative of an activation date.

13. A form tool as claimed in claim 12, wherein the manage routine is operable to initiate data collection after said activation date.

14. A form tool as claimed in claim 10, wherein the management template includes data representative of an expiration date.

15. A form tool as claimed in claim 14, wherein the manage routine is operable to terminate data collection after said expiration date.

16. A form tool as claimed in claim 10, wherein the management template includes data representative of a number of responses.

17. A form tool as claimed in claim 10, wherein the management template includes data representative of a date of the last received response.

18. A form tool as claimed in claim 10, wherein the manage routine is operable to read the management template.

19. A form tool as claimed in claim 10, wherein the manage routine is operable to generate a signal in response to received data.

20. A form tool as claimed in claim 1, wherein the report module includes
a report data template;
a report format template; and
a reporting engine.

21. A form tool as claimed in claim 20, wherein the report data template is at least partially generated by the design template.

22. A form tool as claimed in claim 20, wherein the report format template includes a plurality of nodes.

23. A form tool as claimed in claim 20, wherein the report format template includes data representative of reporting attributes.

24. A form tool as claimed in claim 20, wherein the reporting engine is operable to read the report data template.

25. A form tool as claimed in claim 20, wherein the reporting engine is operable to read the report format template.

26. A form tool as claimed in claim 20, wherein the reporting engine generates an output that causes a display device to display a report.

27. A form tool as claimed in claim 1, wherein the export module includes an export data template;
an exporting template;
an export data file; and
an exporting engine.

28. A form tool as claimed in claim 27, wherein the export data template is at least partially generated from the design template.

29. A form tool as claimed in claim 27, wherein the exporting template includes a plurality of nodes.

30. A form tool as claimed in claim 27, wherein the exporting template includes data representative of exporting attributes.

31. A form tool as claimed in claim 27, wherein the exporting engine is operable to read the export data template.

32. A form tool as claimed in claim 27, wherein the exporting engine generates an export data file.

33. A form tool as claimed in claim 32, wherein the export data file is transferred over a network.

34. A form system comprising:
a display device; and
a processor coupled to the display device and operable to generate a form using a design template, a management template, a reporting template, and an exporting template; the processor operable to produce an output signal by executing a rendering engine and reading the design template, the output signal containing information sufficient to cause at least a portion of the form to be displayed on the display device.

35. A form and data analysis tool comprising:
a form tool having
a form development module including
a design template; and
a form engine that is operable to read the design template;
a form management module;
a report module; and
an export module.

36. A form and data analysis tool as claimed in claim 35, further comprising a feedback tool.

37. A form and data analysis tool as claimed in claim 35, further comprising an online testing tool.

38. A form and data analysis tool as claimed in claim 35, further comprising a geographic analysis tool.

39. A form and data analysis tool as claimed in claim 38, wherein the geographic analysis tool includes a GIS engine.

40. A form and data analysis tool as claimed in claim 38, wherein the geographic analysis tool is operable to process linear and non-linear attitudinal information.

41. A form and data analysis tool as claimed in claim 35, further comprising a forms application and development tool.

42. A form and data analysis tool as claimed in claim 35, further comprising a data query tool.

43. A form and data analysis tool as claimed in claim 35, further comprising a menu tool.

44. A method of generating a form, the method comprising:
creating a design template having a plurality of nodes;
creating a graphical interface having fields associated with the design template;
presenting the graphical interface on a display device;
receiving data through the graphical interface;
populating the design template with form attributes that are based on the data received through the graphical interface;
associating groups of attributes with nodes of the design template;
storing the design template in a database;
reading the design template from the database using a form engine;
processing data based on form attributes using the form engine; and
rendering the processed data as a form on the display device.

45. A method as claimed in claim 44, further comprising:
creating a management template having a plurality of nodes;
populating the management template with management attributes that are based on the data received through a graphical interface;
associating groups of attributes with nodes of the management template;
storing the management template in a database;
reading the management template from the database using a manage routine;
processing data based on management attributes using the manage routine; and
applying the processed data based on management attributes to a selected form.

46. A method as claimed in claim 44, further comprising:
creating a report data template at least partially from a design template and with a plurality of nodes;
creating a report format template having a plurality nodes;
populating the report format template with reporting attributes that are based on the data received through a graphical interface;
associating groups of attributes with nodes of the report format template;
storing the report format template and report data template in a database;
reading the report format template and report data template from the database using a reporting engine;
processing the data based on reporting attributes using the reporting engine; and
generating a report based on the data in the report format template and report data template.

47. A method as claimed in claim 44, further comprising:
creating an export data template having a plurality of nodes;
populating the export data template with exporting attributes that are based on the data received through a graphical interface;
associating groups of attributes with nodes of the export data template;
storing the export data template in a database;
reading the export data template from the database using an exporting engine;
processing the data based on exporting attributes using the exporting engine; and
generating an export data file.

48. A graphical analysis tool comprising:
a GIS engine operable to extract information from a database populated with data input to electronic forms, the forms being created by a form tool.
